(19) United States
(12) Patent Application Publication
(10) Pub. No.: US 2022/0012773 A1
(43) Pub. Date: Jan. 13, 2022

(54) SYSTEMS AND METHODS FOR DETECTING MULTIPLE USERS OF AN ONLINE ACCOUNT

(71) Applicant: Shopify Inc., Ottawa (CA)

(72) Inventors: John JONG-SUK LEE, Ottawa (CA); Craig S. MILLER, Ottawa (CA)

(21) Appl. No.: 16/924,975

(22) Filed: Jul. 9, 2020

(51) Int. Cl. G06Q 30/02; G06F 21/31; G06F 21/32

(52) U.S. Cl. CPC G06Q 30/0256; G06F 21/32; G06F 21/316; G06Q 30/0271

(57) ABSTRACT

Systems and methods for processing user activity data associated with a master user account over a period of time are disclosed. The method may include: receiving user activity data associated with a master user account, the user activity data collected at a user device over a time period; receiving user biometric data associated with the master user account, the user biometric data generated based on physical interactions of a user with the user device over the time period; identifying a matching sub-user account corresponding to the user within the master user account based on a comparison between the user biometric data and one or more stored action metrics associated with the master user account; and storing the user activity data in association with the sub-user account within the master user account.

### FIELD

The present disclosure relates to web servers and web browsers, and more specifically, to detecting and differentiating between multiple users that may use the same account to access and browse a given website.

### BACKGROUND

Most e-commerce systems operate on the assumption that each user account is registered and accessed by just one individual, and not anyone else. For example, a typical user account only allows one e-mail address, one name, and one address. In cases where multiple users share a user account and computing resources, the user activities of multiple individuals using the same user account may lead to mis-targeted advertisements based on existing fingerprinting, cookies, or token-based technologies used to personalize interactions for a single user.

### SUMMARY

The examples described herein may be implemented in the context of an e-commerce platform, or may be made available for use outside of the e-commerce platform, such as, for example, for use in an online learning system.

The examples described herein may enable a system to process user activity data associated with the same user account, when the activity data were generated by different users. The disclosed systems and methods can differentiate two or more users that may be using the same user account when browsing (or shopping) an e-commerce website. The segregated browsing activity can be tagged with a sub-user account ID and processed for further use, such as for use by an advertisement server to craft better targeted offers, even if multiple users are using the same family or corporate account when browsing the website. In this way, privacy may be maintained across the multiple users despite their sharing a user account. Additionally or alternatively, purchase integrity may be maintained across the multiple users despite those users sharing a user account.

An example method to differentiate the users is based on processing of user action data that are unique to each user. The user action data can be biometric such as keystroke dynamic data, mouse dynamic data, or touchscreen data.

In one aspect, a method of processing user activity data associated with a master user account is provided, the method includes: receiving user activity data associated with a master user account, the user activity data collected at a user device over a time period; receiving user biometric data associated with the master user account, the user biometric data generated based on physical interactions of a user with the user device over the time period; identifying a matching sub-user account corresponding to the user within the master user account based on a comparison between the user biometric data and one or more stored action metrics associated with the master user account; and storing the user activity data in association with the matching sub-user account within the master user account.

In some embodiments, the user activity data may include activity data collected by a web browser executing at the user device.

In some embodiments, the user biometric data may include biometric data corresponding to input received by the web browser.

In some embodiments, the user activity data may include browser history data.

In some embodiments, identifying the matching sub-user account may include generating a new sub-user account for the user responsive to the comparison between the user biometric data and the one or more stored action metrics associated with the master user account not identifying a match; and storing the user activity data in association with the new sub-user account.

In some embodiments, the user biometric data may include at least one of: keystroke dynamic data, mouse dynamic data, and touchscreen data.

In some embodiments, the method may include: determining a current action metric from the user biometric data received; comparing the current action metric to the one or more stored action metrics associated with the master user account in a database; and determining the matching sub-user account based on the comparison between the current action metric and the one or more stored action metrics.

In some embodiments, the one or more stored action metrics may include a plurality of stored action metrics and each of the plurality of stored action metrics corresponds to a respective sub-user account associated with the master user account.

In some embodiments, when the current action metric is equal to or within a defined threshold of an action metric from the plurality of stored action metrics, the matching sub-user account may be determined to be a sub-user account corresponding to that action metric.

In some embodiments, the method may include sending the user activity data and the sub-user account ID to a server for use in generating targeted advertisement offers.

In some embodiments, the method may include: prior to attaching the sub-user account ID of the matching sub-user account to the user activity data, sending the user activity data without any user ID to a server for use in generating targeted advertisement offers, wherein the user activity data has a session ID or a timestamp; and after attaching the sub-user account ID of the matching sub-user account to the user activity data, sending the sub-user account ID together with the session ID or the timestamp to the server.

In some embodiments, the method may include: receiving new user activity data and new user biometric data associated with the master user account; and deleting the new activity data responsive to determining that the new user biometric data does not match an action metric stored in association with the master user account.

In accordance with another aspect of the disclosure, there is provided a system for processing user activity data associated with a master user account, the system includes: a processing device in communication with a memory storage, the processing device configured to execute instructions stored in the memory storage to cause the system to: receive user activity data associated with a master user account, the user activity data collected at a user device over a time period; receive user biometric data associated with the master user account, the user biometric data generated based on physical interactions of a user with the user device over the time period; identify a matching sub-user account corresponding to the user within the master user account based on a comparison between the user biometric data and one or more stored action metrics associated with the master user account; and store the user activity data in association with the matching sub-user account within the master user account.

In some embodiments, the user activity data may include browser history data or shopping data.

In some embodiments, the processing device may be configured to execute instructions stored in the memory storage to cause the system to: generate a new sub-user account for the user responsive to the comparison between the user biometric data and the one or more stored action metrics associated with the master user account not identifying a match; and store the user activity data in association with the new sub-user account.

In some embodiments, the user biometric data may include at least one of: keystroke dynamic data, mouse dynamic data, and touchscreen data.

In some embodiments, the processing device may be configured to execute instructions stored in the memory storage to cause the system to: determine a current action metric based on the user biometric data; compare the current action metric to the one or more stored action metrics associated with the master user account; and determine the matching sub-user account based on the comparison between the current action metric and the one or more stored action metrics.

In some embodiments, the one or more stored action metrics may include a plurality of stored action metrics and each of the plurality of stored action metrics corresponds to a respective sub-user account associated with the master user account.

In some embodiments, when the current action metric is equal to or within a defined threshold of an action metric of the plurality of stored action metrics, the matching sub-user account may be determined to be a sub-user account corresponding to that action metric.

In some embodiments, the processing device may be configured to execute instructions stored in the memory storage to cause the system to: send the user activity data and the sub-user account ID to a server for use in generating targeted advertisement offers.

In some embodiments, the processing device may be configured to execute instructions stored in the memory storage to cause the system to: prior to attaching the sub-user account ID of the matching sub-user account to the user activity data, send the user activity data without any user ID to a server for use in generating targeted advertisement offers, wherein the user activity data includes one of a session ID and a timestamp; and after attaching the sub-user account ID of the matching sub-user account to the user activity data, send the sub-user account ID together with the one of the session ID and the timestamp to the server.

In some embodiments, the processing device may be configured to execute instructions stored in the memory storage to cause the system to: receive new user activity data and new user biometric data associated with the master user account; and delete the new activity data responsive to determining that the new user biometric data does not match an action metric stored in association with the master user account.

In accordance with another aspect of the disclosure, there is provided a non-transitory computer readable medium having stored thereon instructions for processing user activity data associated with a master user account, the instructions including machine executable code which when executed by at least one processor, causes the at least one processor to: receive user activity data associated with a master user account, the user activity data collected at a user device over a time period; receive user biometric data associated with the master user account, the user biometric data generated based on physical interactions of a user with the user device over the time period; identify a matching sub-user account corresponding to the user within the master user account based on a comparison between the user biometric data and one or more stored action metrics associated with the master user account; and store the user activity data in association with the sub-user account within the master user account.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of the e-commerce platform of FIG. 1, showing some details related to application development;

FIG. 4 shows an example data flow that may take place when a purchase is made using the e-commerce platform of FIG. 1;

FIG. 5 is a block diagram illustrating an example implementation of the e-commerce platform of FIG. 1;

FIG. 6 is another block diagram of the e-commerce platform of FIG. 1, showing some details relevant for a master user account and sub-user accounts;

FIG. 7 is a block diagram of a customer device, in accordance with some example embodiments described herein;

FIG. 8 is a flow chart illustrating a method for processing user activity data from different users, in accordance with some example embodiments described herein; and

FIG. 9 is an example table storing action metrics associated with different sub-user accounts in the same master user account.

Similar reference numerals may have been used in different figures to denote similar components.

### DESCRIPTION OF EXAMPLE EMBODIMENTS

The present disclosure will be described in the context of an e-commerce platform, discussed below. However, it should be understood that this discussion is only for the purpose of illustration and is not intended to be limiting. Further, it should be understood that the present disclosure may be implemented in other contexts, and is not necessarily limited to implementation in an e-commerce platform.

Existing systems often assume that a user account is used by only one individual, and retain the browsing and shopping data for the user account together under the assumption that the browsing and shopping data were incurred by the same individual. This is because individuals are traditionally identified by a single unique identifier and the aggregate profile of the individual account, payment information and computing resources is taken to be the “individual”. This may lead to user frustration such as when web content (such as advertisements) targeted at/intended for user A ends up in the browsing (e.g., shopping experience) of user B when users A and B are sharing the same user account.

The examples described herein may enable a system to process user activity data associated with the same user account even though the activity data was generated by different users. Browsing and/or shopping activity for each of those different users may be segregated. In particular, the segregated browsing or shopping activity may be tagged with a sub-user account ID. The segregated data may be processed for further use, such as, for example, for use by an advertisement server to craft better targeted offers for each sub-user. In this way, targeted offers may be provided for each sub-user, despite the sub-user accounts corresponding to multiple users using the same family or corporate account when browsing the website.

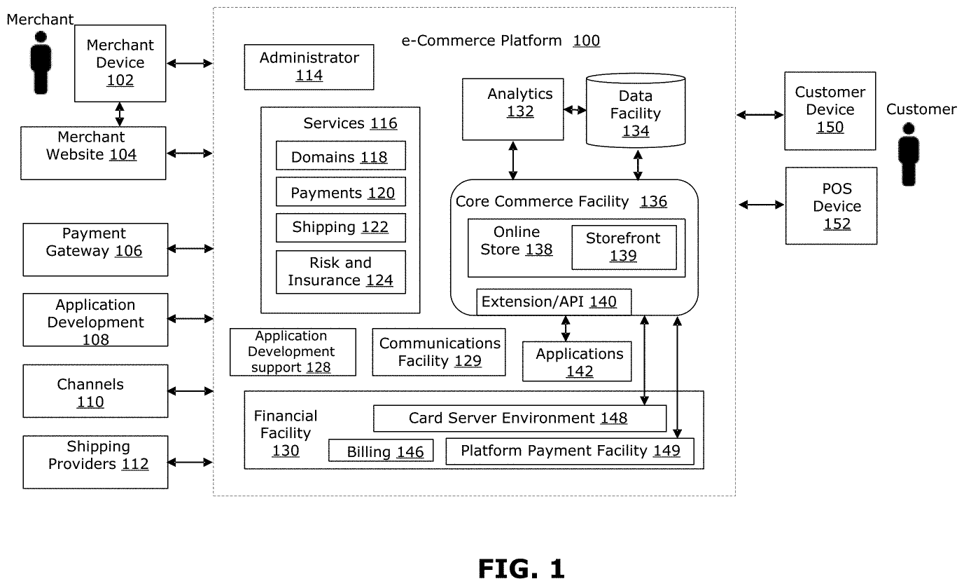

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products or offerings. All references to products or offerings throughout this disclosure should also be understood to be references to products and/or services, including physical products, digital content, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, it should be understood that aspects of the e-commerce platform 100 may be more generally available to support users in an e-commerce environment, and all references to merchants and customers throughout this disclosure should also be understood to be references to users, such as where a user is a merchant-user (e.g., a seller, retailer, wholesaler, or provider of products) and a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Further, it should be understood that any individual or group of individuals may play more than one role and may fit more than one label in the e-commerce environment. For example, a corporate user may also be a customer.

The e-commerce platform 100 may provide a centralized system for providing merchants with online resources for managing their business. Merchants may utilize the e-commerce platform 100 for managing commerce with customers, such as by implementing an e-commerce experience with customers through an online store 138, through channels 110, through point of sale (POS) devices 152 in physical locations (e.g., a physical storefront or other location such as through a kiosk, terminal, reader, printer, 3D printer, and the like), by managing their business through the e-commerce platform 100, by interacting with customers through a communications facility 129 of the e-commerce platform 100, or any combination thereof. A POS device 152 may include, for example, a mobile POS device, a cashier POS terminal, or a self-checkout POS station.

The online store 138 may represent a multitenant facility comprising a plurality of virtual storefronts 139. In various embodiments, merchants may manage one or more storefronts 139 in the online store 138, such as through a merchant device 102 (e.g., computer, laptop computer, mobile computing device, and the like), and offer products to customers through a number of different channels 110 (e.g., an online store 138; a physical storefront through a POS device 152; electronic marketplace, through an electronic buy button integrated into a website or social media channel such as on a social network, social media page, social media messaging system; and the like). A merchant may sell across channels 110 and then manage their sales through the e-commerce platform 100. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront 139 through the online store 138, and utilizing the communications facility 129 to leverage customer interactions and analytics 132 to improve the probability of sales, for example.

In various embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication, and the like, providing a system for reaching customers and facilitating merchant services for the real or virtual pathways available for reaching and interacting with customers.

In various embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application development 108, channels 110, shipping providers 112, customer devices 150, POS devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a thin client via a web browser, accessed through by POS devices, and the like). In various embodiments, elements of the e-commerce platform 100 may be implemented to operate on various platforms and operating systems, such as iOS, Android, over the internet, and the like.

In various embodiments, storefronts 139 may be served by the e-commerce platform 100 to customers (e.g., via customer devices 150), where customers can browse and purchase the various products available (e.g., add them to a cart, purchase immediately through a buy-button, and the like). Storefronts 139 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their storefront 139. Merchants may customize the look and feel of their website through a theme system, such as where merchants can select and change the look and feel of their storefront 139 by changing their theme while having the same underlying product and business data shown within the storefront's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a basic content management system for website content. Merchants may author blog posts or static pages and publish them to their storefront 139 and/or website 104, such as through blogs, articles, and the like, as well as configure navigation menus. Merchants may upload images (e.g., for products), video, content, data, and the like to the e-commerce platform 100, such as for storage by the system. In various embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110, including the online store 138, over the telephone, as well as through physical POS devices 152 as described herein. The e-commerce platform 100 may provide business support services 116, an administrator component 114, and the like associated with running an online business, such as providing a domain service 118 associated with their online store, payments services 120 for facilitating transactions with a customer, shipping services 122 for providing customer shipping options for purchased products, risk and insurance services 124 associated with product protection and liability, merchant billing services 146, and the like. Services 116 may be provided via the e-commerce platform 100 or in association with external facilities, such as through a payment gateway 106 for payment processing, shipping providers 112 for expediting the shipment of products, and the like.

In various embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

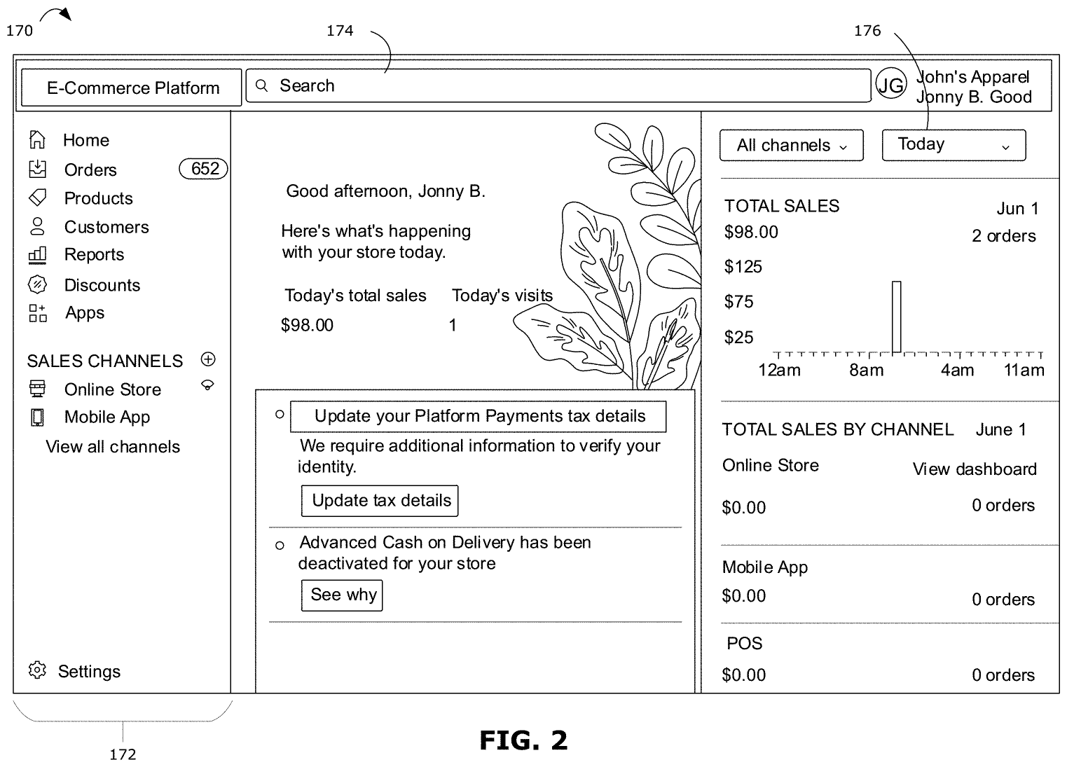

FIG. 2 depicts a non-limiting embodiment for a home page 170 of an administrator 114, which may show information about daily tasks, a store's recent activity, and the next steps a merchant can take to build their business. In various embodiments, a merchant may log in to administrator 114, such as from a browser or mobile device, and manage aspects of their storefront, such as viewing the storefront's recent activity, updating the storefront's catalog, managing orders, recent visits activity, total orders activity, and the like. In various embodiments, the merchant may be able to access the different sections of administrator 114 by using the sidebar 172, such as shown on FIG. 2. Sections of the administrator may include core aspects of a merchant's business, including orders, products, and customers; sales channels, including the online store, POS, and buy button; applications installed on the merchant's account; settings applied to a merchant's storefront 139 and account. A merchant may use a search bar 174 to find products, pages, or other information. Depending on the device the merchant is using, they may be enabled for different functionality through the administrator 114. For instance, if a merchant logs in to the administrator 114 from a browser, they may be able to manage all aspects of their storefront 139. If the merchant logs in from their mobile device, they may be able to view all or a subset of the aspects of their storefront 139, such as viewing the storefront's recent activity, updating the storefront's catalog, managing orders, and the like.

More detailed information about commerce and visitors to a merchant's storefront 139 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110 from different periods of time (e.g., days, weeks, months, and the like), such as by using drop-down menus 176. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's storefront 139, such as based on account status, growth, recent customer activity, and the like. Notifications may be provided to assist a merchant with navigating through a process, such as capturing a payment, marking an order as fulfilled, archiving an order that is complete, and the like.

Reference is made back to FIG. 1. The e-commerce platform may provide for a communications facility 129 and associated merchant interface for providing electronic communications and marketing, such as utilizing an electronic messaging aggregation facility (not shown) for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 130 for secure financial transactions with customers, such as through a secure card server environment 148. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 130 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In various embodiments, online store 138 may support a great number of independently administered storefronts 139 and process a large volume of transactional data on a daily basis for a variety of products. Transactional data may include customer contact information, billing information, shipping information, information on products purchased, information on services rendered, and any other information associated with business through the e-commerce platform 100. In various embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

In various embodiments, the e-commerce platform 100 may be configured with a core commerce facility 136 for content management and task automation to enable support and services to the plurality of storefronts 139 (e.g., related to products, inventory, customers, orders, collaboration, suppliers, reports, financials, risk and fraud, and the like), but be extensible through applications 142 that enable greater flexibility and custom processes required for accommodating an ever-growing variety of merchant storefronts 139, POS devices 152, products, and services. For instance, the core commerce facility 136 may be configured for flexibility and scalability through portioning (e.g., sharding) of functions and data, such as by customer identifier, order identifier, storefront identifier, and the like. The core commerce facility 136 may accommodate store-specific business logic and a web administrator. The online store 138 may represent a channel, be embedded within the core commerce facility 136, provide a set of support and debug tools that support uses for merchants, and the like. The core commerce facility 136 may provide centralized management of critical data for storefronts 139.

The core commerce facility 136 includes base or “core” functions of the e-commerce platform 100, and as such, as described herein, not all functions supporting storefronts 139 may be appropriate for inclusion. For instance, functions for inclusion into the core commerce facility 136 may need to exceed a core functionality threshold through which it may be determined that the function is core to a commerce experience (e.g., common to a majority of storefront activity, such as across channels, administrator interfaces, merchant locations, industries, product types, and the like), is re-usable across storefronts (e.g., functions that can be re-used/modified across core functions), limited to the context of a single storefront at a time (e.g., implementing a storefront ‘isolation principle’, where code should not be able to interact with multiple storefronts at a time, ensuring that storefronts cannot access each other's data), provide a transactional workload, and the like. Maintaining control of what functions are implemented may enable the core commerce facility 136 to remain responsive, as many required features are either served directly by the core commerce facility 136 or enabled by its extension/application programming interface (API) 140 connection to applications 142. If care is not given to restricting functionality in the core commerce facility 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the core commerce facility 136 may be configured to maintain responsiveness, such as through configuration that utilizes timeouts, queues, back-pressure to prevent degradation, and the like.

Although isolating storefront data is important to maintaining data privacy between storefronts 139 and merchants, there may be reasons for collecting and using cross-store data, such as for example, with an order risk assessment system or a platform payment facility, both of which require information from a majority of storefronts 139 to perform well. In various embodiments, rather than violating the isolation principle, it may be preferred to move these components out of the core commerce facility 136 and into their own infrastructure within the e-commerce platform 100. For example, the data facility 134 and analytics 132 may be located outside the core commerce facility 136.

In various embodiments, the e-commerce platform 100 may provide for a platform payment facility 149, which is another example of a component that utilizes data from the core commerce facility 138 but may be located outside so as to not violate the isolation principle. The platform payment facility 149 may allow customers interacting with storefronts 139 to have their payment information stored safely by the core commerce facility 136 such that they only have to enter it once. When a customer visits a different storefront 139, even if they've never been there before, the platform payment facility 149 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from a storefront's checkout, allowing information to be made available globally across storefronts 139. It would be difficult and error prone for each storefront 139 to be able to connect to any other storefront 139 to directly retrieve the payment information stored there. As a result, the platform payment facility 149 may be implemented external to the core commerce facility 136.

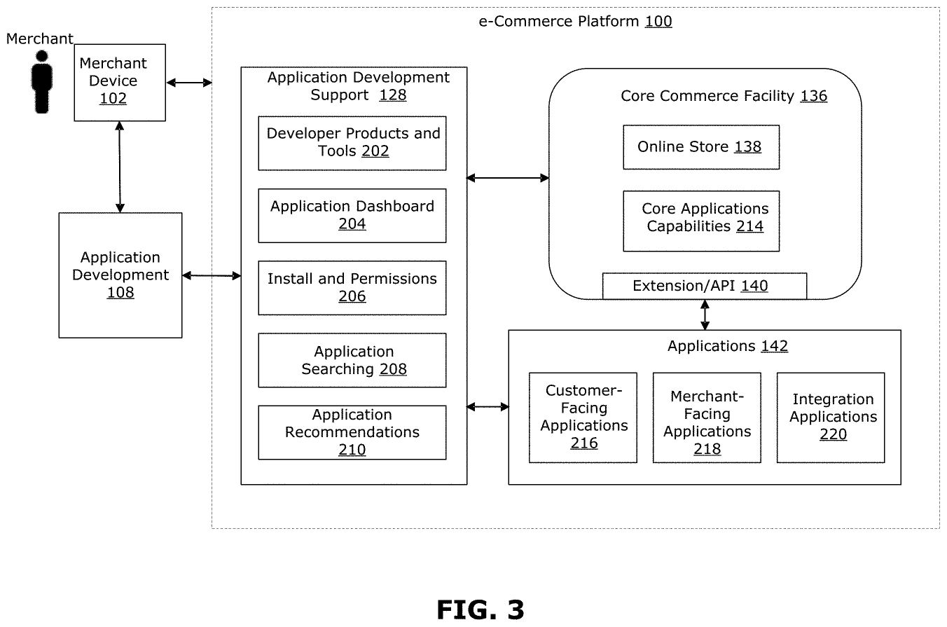

For those functions that are not included within the core commerce facility 138, applications 142 provide a way to add features to the e-commerce platform 100. Applications 142 may be able to access and modify data on a merchant's storefront 139, perform tasks through the administrator 114, create new flows for a merchant through a user interface (e.g., that is surfaced through extensions/API 140), and the like. Merchants may be enabled to discover and install applications 142 through application searching 208 and application recommendations 210 (see FIG. 3). In various embodiments, core products, core extension points, applications, and the administrator 114 may be developed to work together. For instance, application extension points may be built inside the administrator 114 so that core features may be extended by way of applications 142, which may deliver functionality to a merchant through the extension/API 140.

In various embodiments, applications 142 may deliver functionality to a merchant through the extension/API 140, such as where an application 142 is able to surface transaction data to a merchant (e.g., App: “Surface my app in mobile and web admin using the embedded app SDK”), and/or where the core commerce facility 136 is able to ask the application to perform work on demand (core: “App, give me a local tax calculation for this checkout”).

Applications 142 may support storefronts 139 and channels 110, provide merchant support, integrate with other services, and the like. Where the core commerce facility 136 may provide the foundation of services to the storefront 139, the applications 142 may provide a way for merchants to satisfy specific and sometimes unique needs. Different merchants will have different needs, and so may benefit from different applications 142. Applications 142 may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142 may be connected to the core commerce facility 136 through an extension/API layer 140, such as utilizing APIs to expose the functionality and data available through and within the core commerce facility 136 to the functionality of applications (e.g., through REST, GraphQL, and the like). For instance, the e-commerce platform 100 may provide API interfaces to merchant and partner-facing products and services, such as including application extensions, process flow services, developer-facing resources, and the like. With customers more frequently using mobile devices for shopping, applications 142 related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the core commerce facility 136, thus providing merchants what they need when they need it. For instance, shipping services 122 may be integrated with the core commerce facility 136 through a shipping or carrier service API, thus enabling the e-commerce platform 100 to provide shipping service functionality without directly impacting code running in the core commerce facility 136.

Many merchant problems may be solved by letting partners improve and extend merchant workflows through application development, such as problems associated with back-office operations (merchant-facing applications) and in the storefront (customer-facing applications). As a part of doing business, many merchants will use mobile and web related applications on a daily basis for back-office tasks (e.g., merchandising, inventory, discounts, fulfillment, and the like) and storefront tasks (e.g., applications related to their online shop, for flash-sales, new product offerings, and the like), where applications 142, through extension/API 140, help make products easy to view and purchase in a fast growing marketplace. In various embodiments, partners, application developers, internal applications facilities, and the like, may be provided with a software development kit (SDK), such as through creating a frame within the administrator 114 that sandboxes an application interface. In various embodiments, the administrator 114 may not have control over nor be aware of what happens within the frame. The SDK may be used in conjunction with a user interface kit to produce interfaces that mimic the look and feel of the e-commerce platform 100, such as acting as an extension of the core commerce facility 136.

Applications 142 that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the core commerce facility 136, such as for synchronizing a local database, notifying an external integration partner, and the like. Update events may enable this functionality without having to poll the core commerce facility 136 all the time to check for updates, such as through an update event subscription. In various embodiments, when a change related to an update event subscription occurs, the core commerce facility 136 may post a request, such as to a predefined callback URL. The body of this request may contain a new state of the object and a description of the action or event. Update event subscriptions may be created manually, in the administrator facility 114, or automatically (e.g., via the API). In various embodiments, update events may be queued and processed asynchronously from a state change that triggered them, which may produce an update event notification that is not distributed in real-time.

Reference is made to FIG. 3, which is another depiction of the e-commerce platform 100. FIG. 3 omits some details that have been described with reference to FIG. 1, and shows further details discussed below. In various embodiments, the e-commerce platform 100 may provide application development support 128. Application development support 128 may include developer products and tools 202 to aid in the development of applications, an application dashboard 204 (e.g., to provide developers with a development interface, to administrators for management of applications, to merchants for customization of applications, and the like), facilities for installing and providing permissions 206 with respect to providing access to an application 142 (e.g., for public access, such as where criteria must be met before being installed, or for private use by a merchant), application searching 208 to make it easy for a merchant to search for applications 142 that satisfy a need for their storefront 139, application recommendations 210 to provide merchants with suggestions on how they can improve the user experience through their storefront 139, a description of core application capabilities 214 within the core commerce facility 136, and the like. These support facilities may be utilized by application development 108 performed by any entity, including the merchant developing their own application 142, a third-party developer developing an application 142 (e.g., contracted by a merchant, developed on their own to offer to the public, contracted for use in association with the e-commerce platform 100, and the like), or an application being developed by internal personal resources associated with the e-commerce platform 100. In various embodiments, applications 142 may be assigned an application identifier (ID), such as for linking to an application (e.g., through an API), searching for an application, making application recommendations, and the like.

The core commerce facility 136 may include base functions of the e-commerce platform 100 and expose these functions through APIs to applications 142. The APIs may enable different types of applications built through application development 108. Applications 142 may be capable of satisfying a great variety of needs for merchants but may be grouped roughly into three categories: customer-facing applications 216, merchant-facing applications 218, or integration applications 220. Customer-facing applications 216 may include storefront 139 or channels 110 that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 218 may include applications that allow the merchant to administer their storefront 139 (e.g., through applications related to the web or website or to mobile devices), run their business (e.g., through applications related to POS devices 152), to grow their business (e.g., through applications related to shipping (e.g., drop shipping), use of automated agents, use of process flow development and improvements), and the like. Integration applications 220 may include applications that provide useful integrations that participate in the running of a business, such as shipping providers 112 and payment gateways.

In various embodiments, an application developer may use an application proxy to fetch data from an outside location and display it on the page of an online storefront 139. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142 so that the core commerce facility 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110, adds what they intend to buy to their cart, proceeds to checkout, and pays for the content of their cart resulting in the creation of an order for the merchant. The merchant may then view and fulfill (or cancel) the order. The product is then delivered to the customer. If the customer is not satisfied, they might return the products to the merchant.

In an example embodiment, a customer may browse a merchant's products on a channel 110. A channel 110 is a place where customers can view and buy products. In various embodiments, channels 110 may be modeled as applications 142 (a possible exception being the online store 138, which is integrated within the core commence facility 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In various embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., “secret” strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110 may use the core commerce facility 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through the card server environment 148. In various embodiments, the payment gateway 106 may accept international payment, such as integrating with leading international credit card processors. The card server environment 148 may include a card server application, card sink, hosted fields, and the like. This environment may act as the secure gatekeeper of the sensitive credit card information.

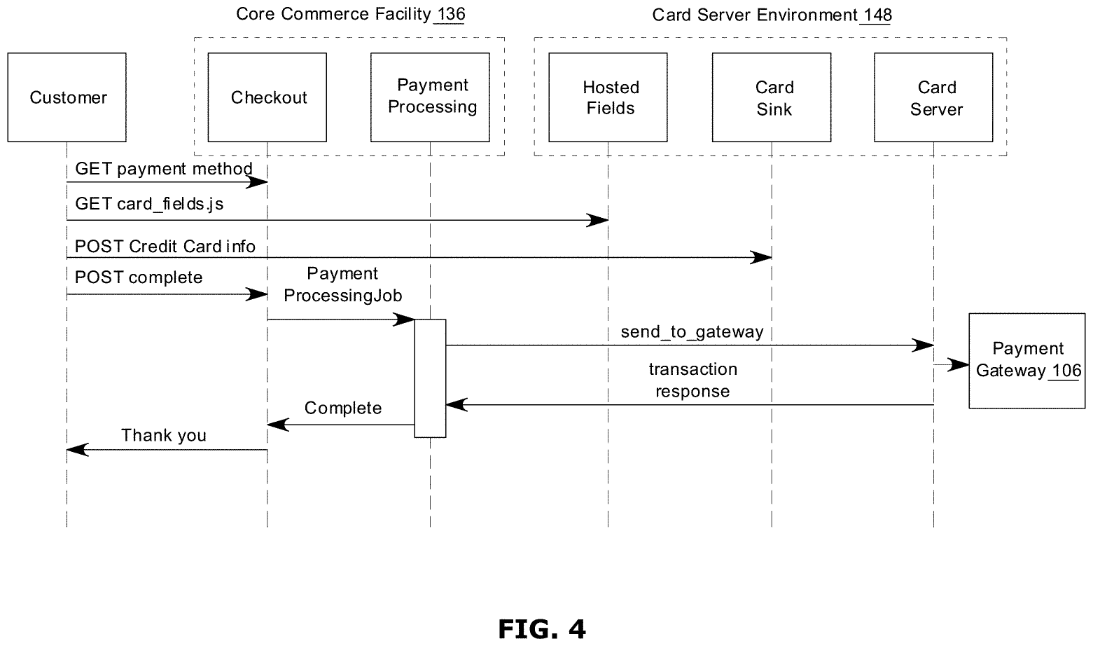

FIG. 4 presents, in a non-limiting example, a simplified sequence diagram of the interactions between the core commerce facility 136 and the card server environment 148 during payment processing of a credit, prepaid, gift or other card on a Web Checkout.

In various embodiments, most of the process may be orchestrated by a payment processing job. The core commerce facility 136 may support many other payment methods, such as through an offsite payment gateway 106 (e.g., where the customer is redirected to another website), manually (e.g., cash), via a POS device or terminal, online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110 that do not rely on core commerce facility checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor). The merchant may then view and fulfill (or cancel) the order.

An order assessment component may implement a business process merchants use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In various embodiments, this business process may be implemented by a fulfillment component. The fulfillment component may group the line items of the order into a logical fulfillment unit of work based on an inventory location and fulfillment service. The merchant may assess the order, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the core commerce facility 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a returns component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that were not returned and remain in the customer's hands); and the like. A return may represent a change to the contract of sale (e.g., the order), and where the e-commerce platform 100 may make the merchant aware of compliance issues with respect to legal obligations (e.g., with respect to taxes). In various embodiments, the e-commerce platform 100 may enable merchants to keep track of changes to the contract of sales over time, such as implemented through a sales model component (e.g., an append-only date-based ledger that records sale-related events that happened to an item).

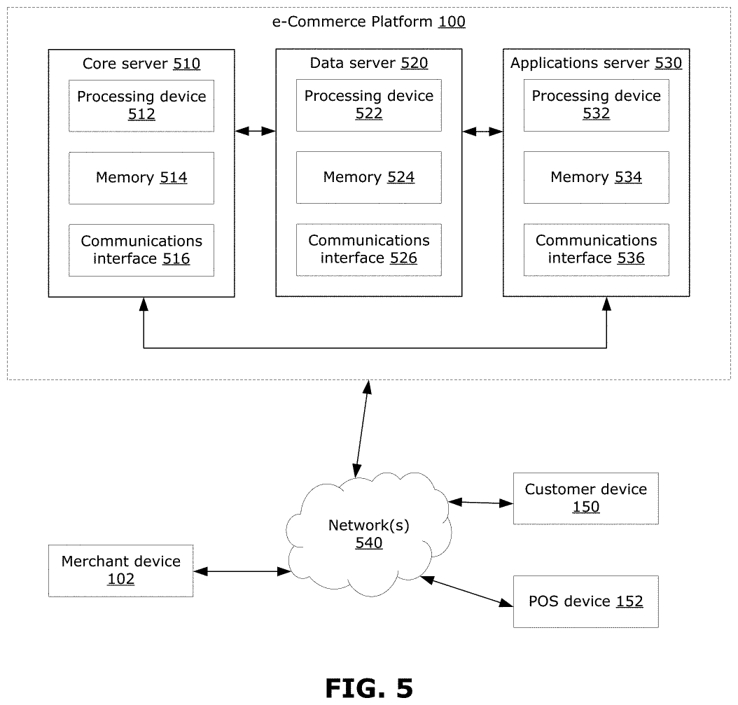

FIG. 5 is a block diagram of an example hardware configuration of the e-commerce platform 100. It should be noted that different components of the e-commerce platform 100 (e.g., the data facility 134, analytics facility 132, core commerce facility 136 and applications 142) may be implemented in separate hardware or software components, on a common hardware component or server or configured as a common (integrated) service or engine in the e-commerce platform 100. In the example of FIG. 5, the e-commerce platform 100 includes a core server 510, a data server 520 and an applications server 530, which are each in communication with each other (e.g., via wired connections and/or via wireless intranet connections). Each of the servers 510, 520, 530 include a respective processing device 512, 522, 532 (each of which may be, for example, a microprocessor, graphical processing unit, digital signal processor or other computational element), a respective memory 514, 524, 534 (each of which may be, for example, random access memory (RAM), read only memory (ROM), hard disk, optical disc, subscriber identity module (SIM) card, memory stick, secure digital (SD) memory card, and the like, and may include tangible or transient memory), and a respective communications interface 516, 526, 536 (each of which may include transmitter, receiver and/or transceiver for wired and/or wireless communications). The core server 510 may store instructions and perform operations relevant to core capabilities of the e-commerce platform, such as providing the administrator 114, analytics 132, core commerce facility 136, services 116 and/or financial facility 130, among others. The data server 520 may be used to implement the data facility 134, among others. The applications server 530 may store instructions and perform operations relevant to the applications 142, such as storing instructions and data for the applications 142 and for implementing application development support 128.

Merchants and customers, using respective devices 102, 150, 152 may access the e-commerce platform 100 via one or more networks 540 (e.g., wired and/or wireless networks, including a virtual private network (VPN), the Internet, and the like).

Although FIG. 5 illustrates an example hardware implementation of the e-commerce platform 100, it should be understood that other implementations may be possible. For example, there may be greater or fewer numbers of servers, the e-commerce platform 100 may be implemented in a distributed manner, or at least some of the memories 514, 524, 534 may be replaced with external storage or cloud-based storage, among other possible modifications.

Throughout this disclosure, a master user account refers to a user account that can be associated with two or more sub-user accounts, if two or more different users are detected to be using the master user account to browse virtual storefronts or websites hosted by e-commerce platform 100. A master user account may appear as a normal user account to a user; and the sub-user accounts may not be apparent to the user of a master user account. A master user account has one set of login information, e.g., user credentials. Two different master user accounts have two different sets of login information.

Each master user account has its own set of user profile information (e.g. name, address, loyalty number if applicable, payment information), user settings, as well as user activity data. User activity data can include any type of user data relating to a user's browsing session(s). For example, user activity data can include browsing history and purchasing history.

A sub-user account exists solely within a master user account. Within the same master user account there may be two or more sub-user accounts. Sub-user accounts within the same master user account share the same login information, i.e., the login information of the master user account. User settings across the sub-user accounts in the same master user account may also be the same, or may be different. Each sub-user account is identified using a unique sub-user account ID.

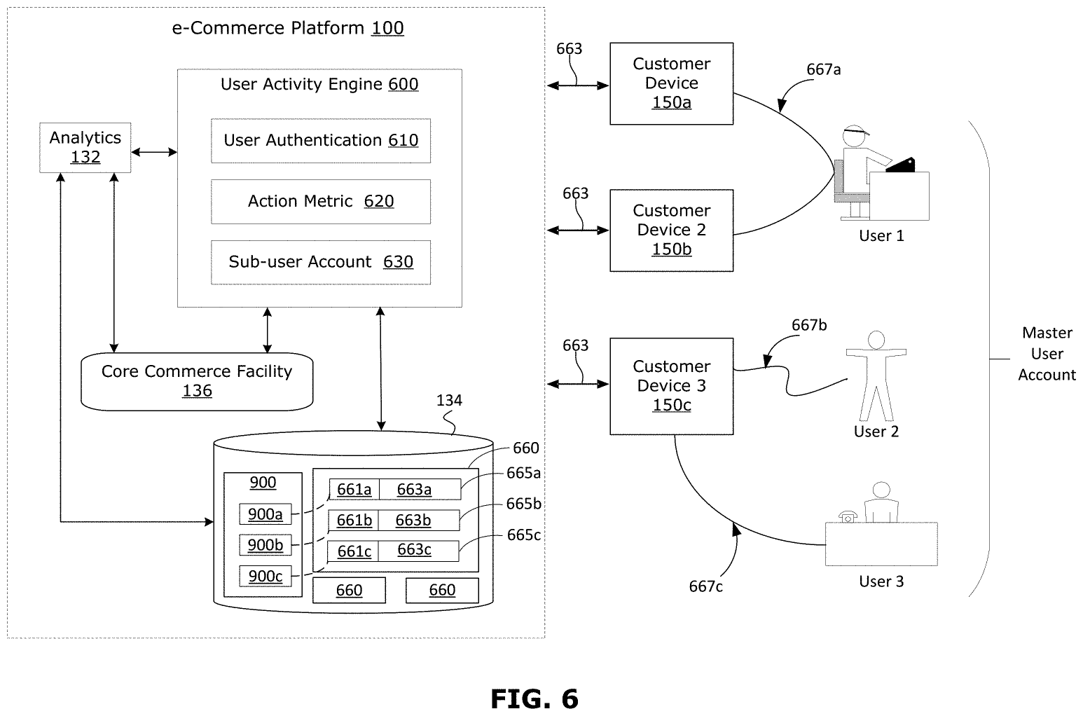

FIG. 6, which is a depiction of the e-commerce platform 100 that omits some details that have been described with reference to FIG. 1 and shows further details discussed below, will now be discussed. In particular, as further explained below, FIG. 6 illustrates some details of the e-commerce platform 100 that are relevant to a master user account.

Referring to FIG. 6, in some example embodiments, the e-commerce platform 100 may be configured to receive user activity data from multiple users using one or more customer devices 150a, 150b, 150c. A customer device 150a, 150b, 150c may be a computing device operable to allow a user to browse online and receive user input such as, for example, a computer, a laptop, a mobile computing device (e.g., a smartphone), or the like A user (depicted as “User 1” in FIG. 6), who may also be referred to as a customer throughout this disclosure, may use one or more customer devices 150a, 150b concurrently or at different points in time. Multiple users (depicted as “User 2” and “User 3” in FIG. 6) may share the same device 150c at different points in time. Two or more users (e.g., User 1 and User 3) may access e-commerce platform 100 using a single master user account, concurrently, or at different points in time. After a user has logged into a master user account, his or her user activity data 663 in a browsing session can be stored and associated with the master user account. In some embodiments, the user activity data 663 may be analyzed and associated with a sub-user account, as described in greater detail further below.

A browsing session can be defined as a continuous period of user activity in a given browser, where successive user actions are separated by no more than a maximum time threshold, e.g. 30 minutes, before the user closes a browser. The maximum time threshold may be pre-defined. Other ways to define a browsing session, which may not be based on defined time thresholds, may also be used. User actions may include browsing a page, opening a new page, downloading, uploading, making a purchase, logging into or out of a user account. A browsing session can be associated with a start timestamp and an end timestamp, and identified by a unique browsing session identifier. The unique browsing session identifier may be associated with a user account, which may be a master user account, a sub-user account or both, so as to link user activity data 663 generated in the particular browsing session identified by the unique browsing session identifier to the master and/or sub-user account.

In the example illustrated in FIG. 6, the e-commerce platform 100 includes a user activity engine 600. The user activity engine 600 may be part of the applications 142 or services 116 of the e-commerce platform 100 for example, or may be a standalone component of the e-commerce platform 100. The user activity engine 600 may, for example, be implemented by the applications server 530 of FIG. 5. In other implementations, the user activity engine 600 may be implemented as a standalone component or service external to the e-commerce platform 100.

The user activity engine 600 is configured to communicate with one or more customer devices 150a, 150b, 150c via a network 540, which may be a wireless connection. In the illustrated example, the user activity engine 600 has three modules: a user authentication module 610, an action metric module 620, and a sub-user account module 630, and may be in communication with the core commerce facility 136, the data facility 134, and the analytics 132.

User authentication module 610 is operable to register and authenticate users prior to providing access to databases and advanced functions of the e-commerce platform 100. In some example embodiments, the user authentication module 610 may receive user authentication information from a customer device 150a, 150b, 150c, and verify the user authentication information against existing user data (e.g. a user account) from a user database, which may be stored at data facility 134. User authentication information may include any one or more of: a username and password combination, a token generated in real time, a pre-defined pattern of numbers and/or letters, a passcode or a passphrase, and a biometric input such as a fingerprint scan, a facial scan, an iris pattern, a retina pattern, and a voice recording. After the user authentication information has been verified, the user authentication module 610 may send a message to the customer devices 150a, 150b, 150c confirming that the user authentication information is accurate and the user has logged into a user account. At this point, the user has logged into a master user account 660.

As mentioned, a master user account 660 refers to a user account that can be associated with two or more sub-user accounts 665a, 665b, 665c, such as if two or more different users are detected to be using the master user account 660 to browse virtual storefronts or websites hosted by e-commerce platform 100.

Each master user account 660 is associated with one or more sets of user activity data 663. User activity data 663 may include any type of user data relating to a user's browsing session(s). For example, user activity data 663 may include browsing history and purchasing history. Browsing history may include a detailed log or record of websites a user has visited in the past, including information such as a name of each website, a visit timestamp of each website, a visit duration of each website, a web link of each website, download history, search history, and cookies. User activity data 663 may be associated with a master user account 660, and further associated with a sub-user account 665a, 665b, 665c within the master user account 660, if a sub-user account 665a, 665b, 665c is identified for the user activity data 663.

In a simple embodiment, a sub user account 665a, 665b, 665c may be associated with a respective set of historical user activity data 663a, 663b, 663c stored in association with a respective unique sub-user account ID 661a, 661b, 661c. However, in some embodiments, sub-user accounts 665a, 665b, 665c and respective sub-user account ID 661a, 661b, 661c may be used to track user activity data 663 determined to have been generated by two or more different users that use the same master user account 660 to access websites hosted by the e-commerce platform 100, where each identified user is assigned and associated with a unique sub-user account ID 661a, 661b, 661c.

The user activity engine 600 receives user activity data 663 generated over a time period T during a browsing session that has been associated with a master user account 660. For example, the user activity engine 600 may receive the user activity data 663 from a customer device 150a, 150b, 150c. However received, responsive to receiving the user activity data 663, the user activity engine 600 may store the user activity data 663 in data facility 134 and may associate or link the stored user activity data 663 with the specific master user account 660.

The user activity engine 600 may determine whether the user activity data 663 generated during the time period T ought to be associated with an existing or new sub-user account 665a, 665b, 665c in the master user account 660. The determination may be made based on user action data received from a customer device 150a, 150b, 150c. The determination may be made periodically, e.g. every 5 seconds or 5 minutes. Additionally or alternatively, the determination may be made when a volume of user activity data 663 surpasses a defined threshold (e.g. 50 KB of new user activity data 663 received since last determination).

At least two types of user action data can be utilized, alone or in combination, namely 1) user biometric data 667a, 667b, 667c such as, for example, keystroke dynamic data, mouse dynamic data, or touchscreen data; and 2) browsing history and in particular, shopping history data, as may be included in the user activity data 663.

### User Biometric Data

Certain types of user biometric data 667a, 667b, 667c such, for example, as keyboard travel speed between two discrete keys, mouse overshoot for target, finger overshoot to a touch target, and many others, may be unique to and/or representative of a given individual. User biometric data 667a, 667b, 667c may be generated when a user interacts with the customer device 150a, 150b, 150c. For example. the customer device 150a, 150b, 150c may generate measurements (implicitly or explicitly) based on the user interactions, as discussed further below. Such measurements may be implicitly or explicitly communicated by the customer device 150a, 150b, 150c to the e-commerce platform 100. For example, a customer device 150a, 150b, 150c may implicitly communicate time-based biometric data 667a, 667b, 667c by transmitting signals with certain temporal spacing, such as, for example, at intervals based on user interaction (e.g. temporal spacing between selection input). In another example, a customer device 150a, 150b, 150c may explicitly communicate keyboard entry-based biometric data 667a, 667b, 667c by measuring speed of keyboard entry and communicating this information. Various techniques may be used to enable the user biometric data 667a, 667b, 667c to be obtained by the e-commerce platform 100, some of which may require explicit user consent. At the e-commerce platform 100, the processing of each type of user biometric data 667a, 667b, 667c may be performed, for example, by an action metric module 620, to compute an action metric 900a, 900b, 900c that is unique to an individual. For example, a user may have typing latency or touch targeting offsets that are unique to him or her.

Each sub-user account 665a, 665b, 665c within a master user account 660 may be associated with a stored action metric 900a, 900b, 900c for at least one type of user biometric data (e.g. keystroke dynamic data) and may be associated with an action metric for each of two or more types of user biometric data 667a, 667b, 667c. The user activity engine 600 may process, in real time or near real time, user biometric data 667a, 667b, 667c to determine a current action metric, and compare the current action metric to the stored action metrics 900a, 900b, 900c to determine if the current action metric matches with any existing stored action metrics 900a, 900b, 900c. A match can be defined as the current action metric being equal to, or within a defined threshold (e.g., 5% margin of error) of a stored action metric 900a, 900b, 900c.

Statistical information (e.g., averaging typing speed, keystroke error rate) regarding a particular type of biometric data is a possible example of an action metric 900a, 900b, 900c. In some embodiments, multiple types of user biometric data may be needed to distinguish one individual from another, e.g. a combination of average typing speed and keystroke error rate. In some embodiments, for one or more sub-user accounts 665a, 665b, 665c associated with a master user account 660, two or more types of biometric data may need to be examined prior to determining a match. For example, for a sub-user account 665a, comparison of the current action metric and a corresponding stored action metric for average typing speed, as well as comparison of the current action metric and a corresponding stored action metric for keystroke error rate, may need to each meet their respective thresholds for a match in order for a match to be found/determined to exist between the user biometric data 667a and the sub-user account 665a.

In some embodiments, if a sub-user account 665a, 665b, 665c has a plurality of stored action metrics 900a, 900b, 900c for a given device, with each stored action metric corresponding to a respective type of biometric data, the user biometric data 667a, 667b, 667c may need to match at least a majority (e.g. over 50%) of the stored action metrics 900a, 900b, 900c in order for a match to be found/determined to exist between the user biometric data 667a, 667b, 667c and the sub-user account 665a, 665b, 665c. In other embodiments, the threshold for matching the sub-user account may be set to a different value, such as 70% or 100% of the stored action metrics 900a, 900b, 900c.

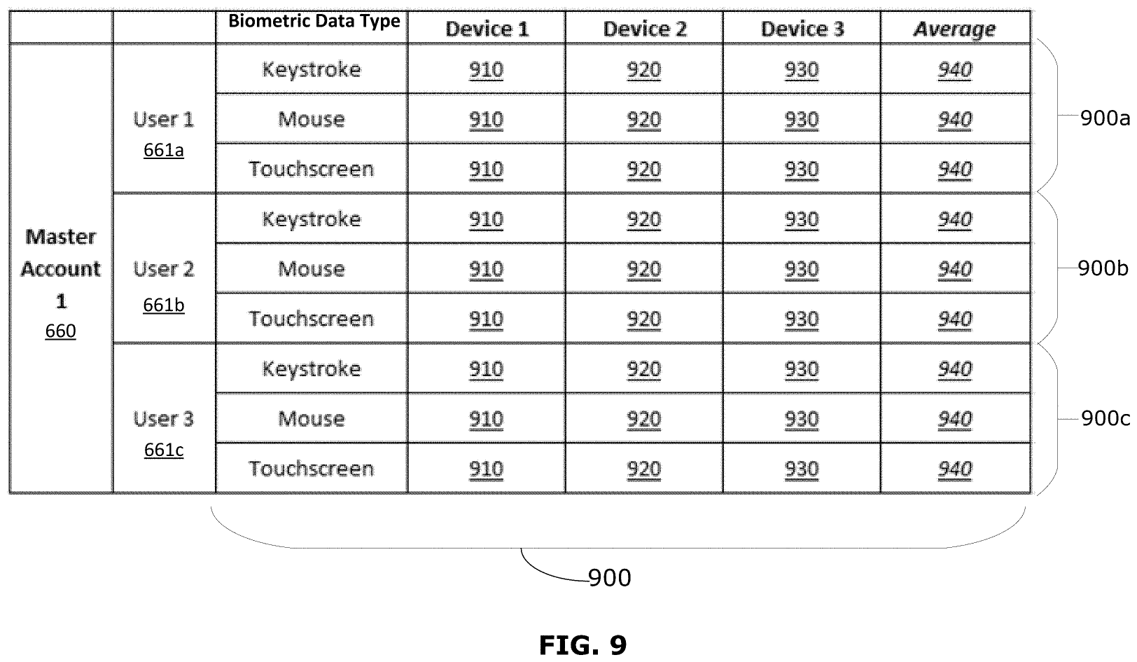

FIG. 9 shows an example table storing action metrics 900a, 900b, 900c associated with different sub-user accounts in the same master user account 660. Each sub-user account is identified by a respective sub-user account ID 661a, 661b, 661c. As shown, a set of stored action metrics 900a, 900b, 900c associated with a sub-user account ID 661a, 661b, 661c may include different action metrics 910, 920, 930, with each action metric generated for a biometric data type (e.g. keystroke, mouse, touchscreen) on a particular device 150a, 150b, 150c. Some devices may only be associated with one or two action metrics based on one or two types of biometric data. For example, a mobile phone may only be associated with action metrics generated based on touchscreen biometric data, while a desktop computer may be associated with action metrics generated based on both keystroke and mouse biometric data.

Typically, a browsing session is conducted over a single customer device 150a, 150b, 150c. However, over time, a user may use different devices 150a, 150b, 150c to sign into the same master user account 660, thereby generating different action metrics corresponding to each of those customer devices—i.e., customer device 150a, 150b, 150c. A customer device 150a, 150b, 150c may be identified based on a unique device ID, which may be sent to the e-commerce platform 100 as part of the browser cookies (or other identifying data) transmitted during a browsing session. Therefore, the action metric module 620 may readily recognize a customer device 150a, 150b, 150c (e.g., based on such identifying data) if the same device has been previously used to browse and generate user activity data 663 in the past.

However, if a user has deleted cookies from a browser or device, then the device ID may be reset, and the action metric module 620 may not be able to recognize the device even if it has been used previously to generate user activity data 663. In these cases, as will be apparent below, the action metric module 620 may still determine that a current browsing session is being conducted over a known (previously used) customer device or a new customer device based on the action metrics 900a, 900b, 900c generated from the user biometric data 667a, 667b, 667c, as a user using the same device can tend to have similar user biometric data 667a, 667b, 667c and therefore similar action metrics 900a, 900b, 900c.

Examples of different possible types of user biometric data 667a, 667b, 667c will now be discussed. As mentioned above, these and other user biometric data may be employed alone in combination in implementations of the subject matter of the present disclosure.

A first example of a possible type of user biometric data 667a, 667b, 667c is keystroke dynamic data. Keystroke dynamic data may be gathered based on how a user types on a physical keyboard of a customer device 150a,150b,150c. For example, keystroke dynamic data may be gathered from measuring the speed at which a user types, the latency in the keystrokes, the amount of pressure applied on the keys, the key combinations used, and a few other things. In some embodiments, when a user is typing, a timestamp of each key press and a corresponding key release may be recorded by the customer device 150a,150b,150c, by the device on which the user is typing, for each key press (and release) in a set of consecutive key presses. The time to press a key, and the time the key is held down may be very characteristic for a user, regardless of how fast the user is typing on the keyboard. Different users may press and/or hold the same sequence of keys differently.

For instance, in English the word “the” is rather common. By examining the differences in timestamps between the key press of T-H and H-E, a pattern may be formed for a user, which can be “0.5 s between T and H, and 0.3 s between H and E”. As more samples on timing differences between individual letters are gathered and calculated, a user may be identified with more confidence. The timing difference between any two letters may be measured and averaged in milliseconds (ms) for a user during a browsing session. Eventually a keystroke action metric may be generated based on the keystroke dynamic data for a user typing on a particular device. The keystroke action metric may be stored in data analytics 134 once it has been determined to be associated with a particular sub-user account.

An example of a second possible type of user biometric data 667a, 667b, 667c is mouse dynamic data, and in particular, mouse targeting data. For example, when a user is using a mouse to target a visual object (e.g. a button) on a screen of a customer device, a target overshoot based on a travel path or vector of a cursor to target and a subsequent offset for a selection can be calculated. For example, when a mouse cursor is being moved towards a target (e.g. a button) based on user input, the cursor may go past (overshoot) the button, and the length of the overshot portion cam considered a “target overshoot”. The cursor may be then brought within the button for clicking, and the length of the movement bringing the cursor to the button may then be considered the “subsequent offset”.

The target overshoot (or undershoot)—for example, in terms of percentage and direction—and a timestamp of a click can be used to generate an action metric 910 for a user using a particular mouse. In a particular example, a pixel (px) to millimeter (mm) or px/mm overshoot conversion may be used to determine the travelled path of the mouse in order to calculate the target overshoot or undershoot. A click rate is the response rate of the mouse click. Therefore, an example mouse action metric for a user may be measured in pixels or mm, and recorded as x pixels or x′ mm overshoot (or undershoot), and may optionally contain a value representative of a target location range, such as y pixels or y′ mm away from the center pixel of the target when a user clicks on the target.

A third type of user biometric data 667a, 667b, 667c can be touchscreen data if the device being used to access the browsing session has a touch-sensitive screen operable to receive user input. For example, touchscreen biometric data can be generated when a user is attempting to touch a visual object on the touch-sensitive screen. A visual target can be defined as a button depicted on-screen. A touch target zone may be the on-screen area that, if touched, will be considered to correspond to a press of the button. The touch target zone is typically larger than the visual target itself. A user's visual target zone may be what the user perceives to be a touch target zone for a target (e.g., what is displayed on the screen). When targeting the visual object, visual target zones are often not aligned with the touch target zones, this is useful to increase targeting accuracy when using touch screen, however the use of the offset from the visual target in sequence can lead to a unique identification of a user. This is the case when multiple targets must be touched, in sequence, and the touch variance between subsequent touches on a known visual position on a touch screen is used to generate a touchscreen action metric, which can be measured in y pixels or y′ mm.

In some embodiments, touchscreen biometric data may be based on a touchscreen swipe gesture. Such data may include an initial touch position (corresponding to the start of the swipe gesture) in pixels and a timestamp of the start of a swipe gesture and a touch release position (corresponding to the end of the swipe gesture) and timestamp of the end of the touch gesture. Additional data may also include one or more of touch pressure, finger/stylus area, speed of motion during the gesture, or acceleration of the touch swipe. As a user makes swiping motions (e.g., using his or her fingers) on the same device (and thus the same touch-sensitive screen), the touchscreen biometric data can be gathered and averaged, and a corresponding touchscreen action metric may be generated as an action metric vector including average values for one or more of: duration of a swipe, pressure of a swipe, finger/stylus area of a swipe, speed of a swipe, and an acceleration of a swipe. Notably, similar biometric data may also be collected for other gestures beyond a simple swipe such as, for example, a multi-finger swipe gesture, a pinch-to-zoom gesture, or the like.

Touchscreen action metric data for a multi-finger swipe gesture may include a separate set of action metric data for each of the fingers detected by the touchscreen of the device. The action metric data may include, for each finger: an initial touch position of the respective finger in pixels, a timestamp of the start of the swipe gesture by the respective finger, a touch release position of the respective finger in pixels, a timestamp of the end of the swipe gesture by the respective finger, average pressure of the swipe gesture, a finger/stylus area of the swipe gesture, an average speed of the swipe gesture, and/or an average acceleration of the swipe gesture.

Touchscreen action metric data for a pinch-to-zoom gesture, which is typically performed by a user using at least two fingers, may include a separate set of action metric data for each of the fingers detected by the touchscreen of the device. The action metric data may include, for each finger: an initial touch position of the respective finger in pixels, a timestamp of the start of the pinch-to-zoom gesture by the finger, a touch release position of the respective finger in pixels, a timestamp of the end of the pinch-to-zoom gesture by the respective finger, average pressure of the pinch-to-zoom gesture, a direction of the pinch-to-zoom gesture by the respective finger, a finger/stylus area of the pinch-to-zoom gesture, an average speed of the pinch-to-zoom gesture, or an average acceleration of the pinch-to-zoom gesture.

Where action metric data for multiple fingers are collected, the action metric data for each of the multiple fingers may be aggregated to form the action metric data for each touchscreen gesture or action detected by the device. For example, the action metric data for a pinch-to-zoom gesture performed with three fingers may be [action metric data for the first finger, action metric data for the second finger, action metric data for the third finger], which may be used to identify an appropriate sub-user account as described below.

The action metric module 620 may be operable to use one or more action metrics to generate a current action metric. Such a current action metric may be compared to stored action metrics in order to find a match. An action metric for a user may include an action metric generated based on one given type of user biometric data (e.g. keystroke dynamic data) during a given time period/interval. Because a browsing session is inherently tied to a single device, the user biometric data gathered over the time period T in a browsing session is assumed to be on one device. Notably, that biometric data may include one, two or more types of user biometric data. Collected biometric data of some or all of those types may be used to generate corresponding action metrics, with some or all of the user biometric data of a given type being used to generate a respective action metric.

In some embodiments, a feature vector may be generated by the action metric module 620 based on the current action metric. If the current action metric only includes a single action metric generated based on keystroke dynamic data, the feature vector may be the average time difference(s) between at least two different keys on a keyboard, e.g., [0.5, 0.3], representing [average time difference between “t” and “h”, average time difference between “h” and “e”].

A feature vector can also be generated by taking two or more current action metrics for a browsing session (or part thereof), and joining them together into an ordered vector (list), which can be generated periodically, such as every 5 seconds. Each element in the feature vector corresponds to a component of a current action metric generated during the relevant period. For example, the feature vector may include a sequence of values—e.g., [A, B, C, D, E, F, G]— corresponding to two or more action metrics—e.g., [vertical mouse target offset, horizontal mouse target offset, average time difference between “t” and “h”, average time difference between “h” and “e”, vertical touch target offset, horizontal touch target offset, average touch swiping pressure, average touch swiping speed]. For example, user A's feature vector might be [−5, 5, 0.5, 0.3, 4, 7, 9, 5], while user B's feature vector might be [2, 8, 0.2, 0.4, 10, 12, −11, 8], and each value in the feature vector may indicate, respectively, [vertical mouse target offset, horizontal mouse target offset, average time difference between “t” and “h”, average time difference between “h” and “e”, vertical touch target offset, horizontal touch target offset, average touch swiping pressure, average touch swiping speed].

The feature vector may be sent to a sub-user account module 630 for matching with one or more action metrics existing in data facility 134 associated with a sub-user account 665a, 665b, 665c. A blank (or null value) in the feature vector may be used to represent a value that is not applicable in the time period T when the user biometric data 667a, 667b, 667d was collected. For example, in a different browsing session, user A's feature vector may be [−4, 6, null, 0.34, 4, 7, null, 5], which may indicate that for user A, the vertical mouse target offset is −4 mm, the horizontal mouse target offset is 6 mm, the average time difference between “t” and “h” is not available, the average time difference between “h” and “e” is 0.34 seconds, the vertical touch target offset is 4 mm, the horizontal touch target offset is 7 mm, the average touch swiping pressure is not available, and the average touch swiping speed is 5 mm per second.

The action metric module 620 may be configured to generate one or more current action metrics based on received user biometric data, and further compute a corresponding feature vector based on the one or more current action metrics for all browsing sessions. The generation and computation of feature vectors may be set to execute periodically (e.g., every 30 seconds) for a browsing session. The action metric module 620 may therefore generate one or more feature vectors for the same user based on the user biometric data received during a particular browsing session. If a browsing session lasts 5 minutes and the action metric module 620 generates one or more current action metrics and a corresponding feature vector every 30 seconds, then multiple corresponding feature vectors may be generated. For example, four feature vectors may be computed during a 2-minute browsing session for a user based on the user biometric data, the feature vectors generated at intervals spaced 30 seconds apart. Each time a current action metric and a corresponding feature vector are generated, the action metric module 620 may send the action metric or the corresponding feature vector to the sub-user account module 630.

In some embodiments, the feature vector can be generated by the customer device 150a, 150b, 150c and sent to the user activity engine 600 at the e-commerce platform 100. Sending a feature vector instead of raw user biometric data may be a more efficient use of communication resources, because a feature vector has a smaller file size, and still includes necessary information on which a sub-user account can be determined, as elaborated herein.

As shown in FIG. 9, each sub-user account having a unique account ID 661a, 661b, 661c has one or more action metrics 910, 920, 930 stored depending on a type of user biometric data collected and a device on which the user biometric data was collected. The device may be identified based on a device number and/or an IP address. Each sub-user account may also have an average action metric 950 stored for each user and each type of user biometric data. In some embodiments, the average action metric 950 may be calculated and stored based on the different action metrics 910, 920, 930 for different devices. The average action metric 950 may be, for instance, a mean value of stored action metrics 910, 920, 930 for the same type of user biometric data across all devices.

When the sub-user account module 630 receives a current action metric or a feature vector, the sub-user account module 630 is operable to compare the current action metric or the feature vector to the stored action metrics 910, 920, 930, 950. The sub-user account module 630 may, depending on the feature vector received from the action metric module 620, generate a comparator vector for each sub-user account ID 661a, 661b, 661c based on the stored action metrics 910, 920, 930, 950. A comparator vector can include average values of one or more action metrics for a sub-user account. The sub-user account module 630 may then compare the feature vector to each comparator vector, in order to determine if a match exists between the feature vector and any comparator vector. A comparator vector may be linked to, or include, the corresponding sub-user account ID 661a, 661b, 661c of the stored action metrics 910, 920, 930, 950 on which the comparator vector is generated.

The comparison for identifying a match between a feature vector and a comparator vector may be performed statistically. For example, standard deviations may be calculated for each value pair between the feature vector and a comparator vector. A value pair includes a value from the feature vector and a corresponding value from the comparator vector, with both values representing the same action metric which can be, for example, a vertical mouse target offset, a horizontal mouse target offset, an average time difference between “t” and “h”, an average time difference between “h” and “e”, a vertical touch target offset, a horizontal touch target offset, an average touch swiping pressure, or an average touch swiping speed. An overall statistical probability can be calculated, which represents a likelihood that the feature vector matches with a particular comparator vector, which is associated with a specific sub-user account ID 661a, 661b, 661c. A minimum threshold may be pre-defined for determining when a match occurs, such that if the statistical probability (the likelihood) is above the minimum threshold, the feature vector is determined to be associated with the sub-user account ID 661a, 661b, 661c of the particular comparator vector. Conveniently, in this way, “fuzzy” matching may be performed between feature vectors and comparator vectors.

In some cases, multiple comparator vectors may appear to be a match for a feature vector, and the sub-user account module 630 may select the comparator vector that has the highest likelihood (e.g. the least standard deviation) of matching the feature vector. In other embodiments, for a given period ending at t₁, the sub-user account module 630 can simply choose the sub-user account ID that has been matched to an immediately preceding feature vector generated during the same browsing session based on user biometric data received at an earlier time t₀, if the time period between t₀ and t₁ is less or equal to a certain threshold (e.g. 5 seconds).

Responsive to finding a match (e.g., each time a match is found), the sub-user account module 630 may update the stored action metric 910, 920, 930, 950 for the particular sub-user account ID 661a, 661b, 661c based on the current action metric received from the action metric module 620, in order to further refine the stored action metric for the sub-user account.

If no match is found—e.g., if the respective likelihood is below the minimum threshold for all comparator vectors—the sub-user account module 630 may assume that the feature vector belongs to a new sub-user within the master user account 660, and may proceed to create a new sub-user account within the master user account 660 for storing the relevant user activity data generated in the time period during which the user biometric data was generated.

In some embodiments, the functions performed by the action metric module 620 may be performed by the customer device 150a, 150b, 150c. As the sensing and collection of user biometric data 667a, 667b, 667c typically happens at the customer device 150a, 150b, 150c, the processing of the user biometric data can be readily carried out by a customer device 150a, 150b, 150c. For example, a software application installed at the customer device 150a, 150b, 150c, or, alternatively, a web browser script running in a browser, may be configured to receive user biometric data 667a, 667b, 667c during a browsing session and generate one or more current action metrics as well as corresponding feature vectors. The current action metrics as well as corresponding feature vectors may then be sent to the user activity engine 600 periodically (e.g. every 30 seconds). In this way, the sub-user account module 630 may receive the current action metrics as well as corresponding feature vectors from the customer device 150a, 150b, 150c. The sub-user account module 630 may then proceed to match each feature vector to an existing sub-user account ID 661a, 661b, 661c. Notably, if a match cannot be found, a new sub-user account may be created.

As mentioned earlier, the user biometric data 667a, 667b, 667c can be gathered over different customer device 150a, 150b, 150c, to distinguish sub-users across different (possibly shared) devices. However, it may be difficult to distinguish users using different devices because the same user may perform differently, thereby producing different action metrics, when using different devices.

In some embodiments, once a match has been made by user activity engine 600 (or customer device 150a, 150b, 150c) between a set of user biometric data 667a, 667b, 667c of a user and a sub-user account ID 661a, 661b, 661c, a message may be sent to the user at the customer device 150a, 150b, 150c, for confirming that the user is (or is not) the identified sub-user of the master user account. For example, the message may indicate that the e-commerce platform 100 has determined that she is likely sub-user Jane Smith having a sub-user account ID 661a, 661b, 661c. Responsive to the message, the user may provide input to the relevant customer device 150a, 150b, 150c. The received input may confirm that the user is indeed the identified sub-user of the master user account, or may instead deny that she is the identified sub-user of the master user account.

In some embodiments, if no match is found between a set of user biometric data 667a, 667b, 667c of a user and a sub-user account ID 661a, 661b, 661c, a message may be sent to the user at the customer device 150a, 150b, 150c, indicating that the e-commerce platform 100 cannot determine a sub-account for her. Responsive to such a message, the customer device may produce output prompting the user to either identify herself as an existing sub-user (e.g. by selecting a name from a displayed list of names associated with the master user account 660), or confirm that she is a new user of the master user account 600. Responsive to the output, the user may provide input to the customer device confirming that she is a new user or identifies her as an existing sub-user (in this case, assumed to be with a new device). The customer device may communicate the input to the e-commerce platform 100. Responsive to receiving such input, the user activity engine 600 may start collecting a baseline action metric for the user in a new or existing sub-user account, respectively, as the case may be. In this way, the problem of different customer devices having different baselines for the same user may be addressed or mitigated.

In some embodiments, machine learning may be implemented in the generation of one or more action metrics or feature vectors based on user biometric data. For example, a keystroke feature may be evaluated against a Gaussian mixed model trained/generated based on biometric data of a particular individual and a threshold may be applied to a likelihood of the feature vector to match any comparator vector generated based on stored action metric of a sub-user account.

In some example embodiments, a one-class machine learning model can be first trained on a given sub-user's known feature vector data to classify a given feature vector as likely belonging to the sub-user account or not. The machine learning model can be trained using a supervised learning method, in which case label input includes multiple sets of feature vector data, and each set of feature vector data has a mapped label category of YES or NO, with YES indicating that the data belongs to the designated sub-user account (i.e., the target class) and NO indicating otherwise (i.e., the outlier class). Example one-class machine learning classification algorithms using supervised learning as may be employed include, without limitation, support vector machines (SVMs), k-nearest neighbour, and neural networks. For example, one-class SVMs (OCSVMs) are supervised learning models that assign new examples into one category or the other (making them non-probabilistic linear classifiers). OCSVMs assume the origin in a kernel space to be the outliner class, and, subsequently, learn a boundary that separates the target class from the outlier class.

In some example embodiments, a multi-class machine learning model can be trained to output a matching sub-user account, if any, from a pool of multiple sub user-accounts. Such a machine learning model can be trained using multiple sets of feature vector data from a plurality of sub-user accounts, where each set of data is mapped with a label representing a specific sub-user account from the plurality of sub-user accounts or with a label representing that the data belongs to no particular sub-user account, as applicable. Once trained, the multi-class machine learning model can receive a given set of feature vector data and, based on the received data, provide a predicted label representative of a corresponding sub-user account, if any. An example multi-class machine learning classification algorithm as may be employed is a recurrent neural network (RNN). An RNN can be trained using feature vector data from a plurality of sub-user accounts, including a plurality of feature vectors for a first sub-user account, a plurality of feature vectors for a second sub-user account, and so on. Each feature vector for a particular sub-account may be collected during a time window (e.g. a 30-second window). In some example embodiments, two or more feature vectors for a particular sub-user account can be stacked together (e.g. sequentially concatenating feature vectors corresponding to multiple time windows) for training a machine model to recognize a sub-user account. In some example embodiments, the training data for a given sub-user account can further include (e.g., be concatenated with) aggregate analysis across those multiple time windows for the sub-user account, including for example, standard deviation or a mean value across the multiple time windows.

Once a multi-class machine learning model is properly trained, it may receive a plurality of sets of feature vector data, and then may output a prediction for a given set of the feature vector data, the prediction including a label indicative of a sub-user account.

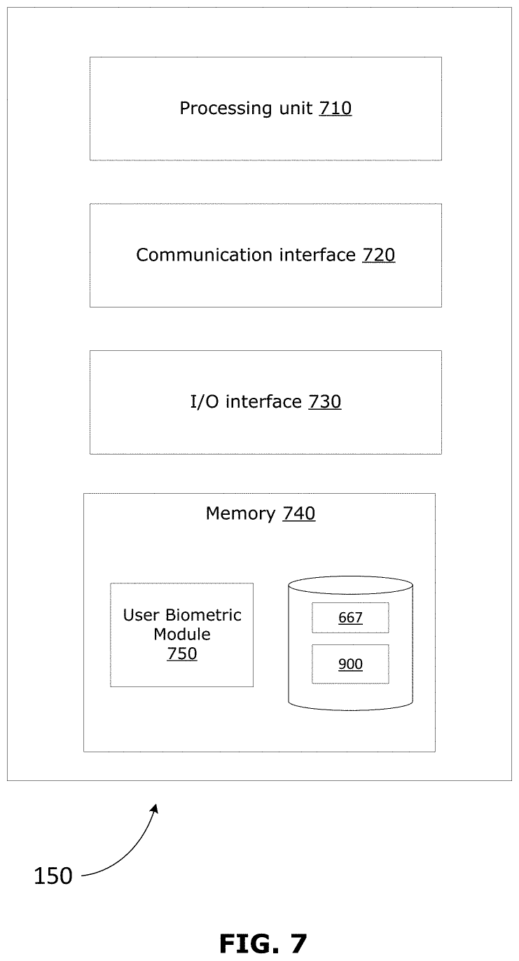

FIG. 7 shows a block diagram of an example customer device 150, according to some embodiments. The customer device 150 may include a processing unit 710, a communication interface 720, an input/output (I/O) interface 730, and one or more memory storage 740. The processing unit 710 can execute instructions stored in/retrieved from the memory 740 to configure a user biometric module 730. The customer device 150 may be connected via a network 540 to the e-commerce platform 100.

The processing unit 710 implements various processing operations of the customer device 150. For example, the processing unit 710 may perform signal coding, data processing, power control, input/output processing, and/or any other functionality of the customer device 150. The processing unit 710 may be configured to implement some or all of the functionality and/or embodiments described in more detail herein. The processing unit 710 may include one or more processing devices. Each processing device may include any suitable processing or computing device as may be configured to perform one or more operations. Each processing unit 710 may, for example, include one or more of a microprocessor, microcontroller, digital signal processor, field programmable gate array, and/or an application specific integrated circuit.

The customer device 150 also includes at least one communication interface 720 for wired and/or wireless communications. Each communication interface 720 includes any suitable structure for generating signals for wireless or wired transmission and/or processing signals received wirelessly or by wire. For example, a communication interface 720 may include a transceiver unit configured to send and receive wireless signals via network 540.

The customer device 150 further includes one or more input/output (I/O) interfaces 730 (such as an interface to wireless network 540). The input/output interfaces 730 permit interaction with a user or other devices in the network. An I/O interface 730 may also include any suitable structure for providing information to or receiving information, such as a speaker, microphone, keypad, display, card reader, camera, and/or a network interface.

In addition, the customer device 150 includes at least one memory 740. The memory 740 stores instructions and data used, generated, or collected by the customer device 150. For example, the memory 740 may store software instructions configured to implement some or all of the functionality and/or embodiments described herein and that are executed by the processing unit 710, such as the user biometric module 750. Each memory 740 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

The memory 740 may include a local storage for storing user biometric data 667 received from a user, and/or one or more action metrics 900 generated based on the user biometric data 667. Local storage may be or may include a database stored in the memory 740. The user biometric module 750 may be configured to process the stored user biometric data 667 received from the user and generate the one or more action metrics 900 periodically, for example, at every 30 seconds.

The user biometric module 750 may send the generated action metric 900 to the action metric module 620 of the user activity engine 600 of the e-commerce platform 100, so that that the action metric module 620 may generate a feature vector based on a given action metric 900. In some embodiments, in addition or as an alternative to sending the action metric 900 to the user activity engine 600, the user biometric module 750 may generate the feature vector based on the action metric 900 and send both the feature vector and, potentially, the action metric 900 to the user activity engine 600, which may use the feature vector to further determine if a match can be found between the feature vector and any comparator feature vectors generated based on stored action metrics 900a, 900b, 900c.

In some embodiments, the customer device 150 may be configured to, through wireless connection with the data facility 134, analyze the user biometric data 667 and determine an appropriate sub-user account ID 661a, 661b, 661c, essentially performing the functions of both the action metric module 620 and the sub-user account module 630 of the user activity engine 600.

### Shopping History Data

In some embodiments, the user activity engine 600 may additionally or alternatively use a browsing or shopping history to identify sub-user accounts. For example, the user activity engine 600 may use a shopping history of each sub-account user within the same master user account 660 to create a shopping social graph. In such a graph, each edge may represent an action taken on a particular product (viewed, added to cart, purchased, etc.), and each node may represent a product and optionally a merchant (e.g., a tuple of product and merchant). Such a graph may be inspected by a processor to identify clustering of strong interconnections to determine a shopping pattern for each sub-account user. For example, many users may be inclined to browse or purchase a second product (e.g. patio umbrella) after browsing or purchasing a first product (e.g. patio dining set). A shopping social graph may be used to further help the user activity data differentiate different sub-users within the same master user account 660. Other techniques for generating clusters in the shopping history of a user may be used.

For example, by using interconnected clusters within the shopping history of a single master user account 660, two or more users may be identified who are making use of a payment card or the same address. The use of clustering may also be used to track adjacent shopping behaviour. Adjacent shopping behaviour refers to the concept that if someone is shopping for a bicycle, he may likely shop for a helmet shortly after the bicycle. In other words, adjacent shopping behaviour refers to the rules-based and/or pattern-recognition-based technique for tracking a user's activity within a realm or category of related products/services.

The clustering of online activity can be used to support using user biometric data for identification of sub-user accounts. For example, in some embodiments, the user activity engine 600 first determines that a current action metric generated based on user biometric data of user C received during a browsing session is a match for a stored action metric associated with a sub-user account S, it then checks to see if a shopping social graph exists for the sub-user account S. If a social graph exists for the sub-user account S, the user activity engine 600 proceeds to review a set of current user activity data of user C based on the social graph of the sub-user account S. When the current user activity data of user C show different shopping behaviours from those suggested by one or more clusters on the social graph of the sub-user account S, the user activity engine 600 can determine that additional user biometric data and action metric may be required to further determine if user C should be the owner of the sub-user account S. In this case, the user activity engine 600 proceeds to analyze at least one more set of user biometric data of user C to generate a most recent current action metric in order to determine if user C should be matched to sub-user account S. If the corresponding current action metric of user C is matched to the sub-user account S again, then the user activity engine 600 can conclude that the match is correct, otherwise, the user activity engine 600 can conclude that the match is incorrect and user C may be deemed to be a new sub-user for the master user account.

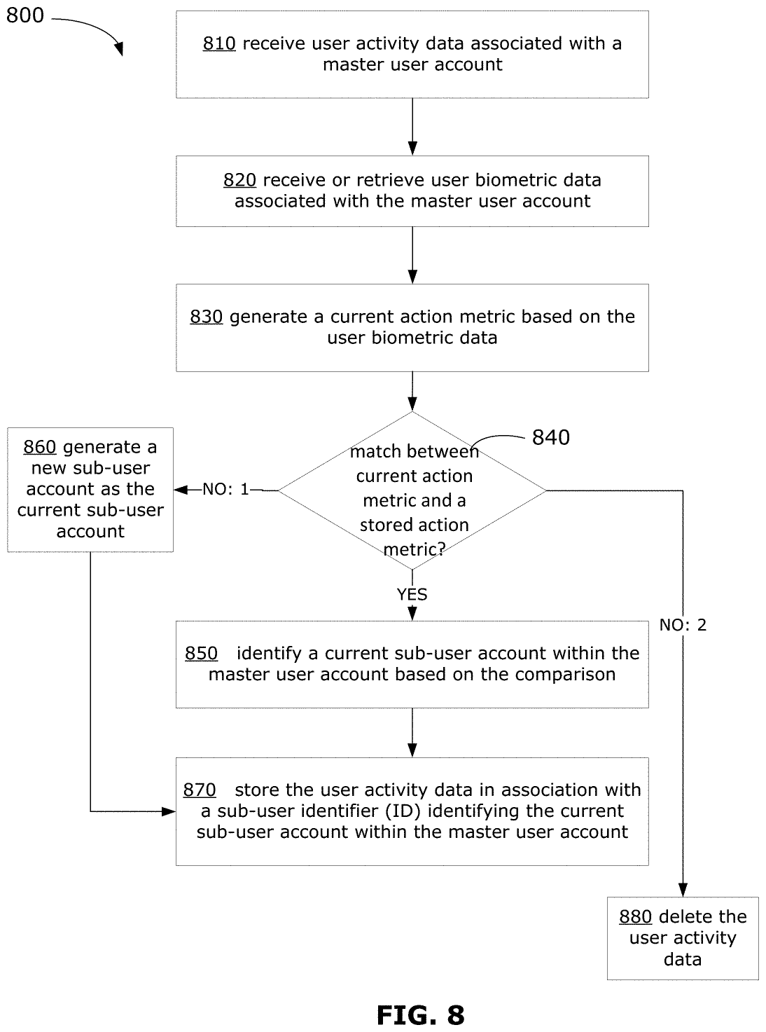

FIG. 8 is a flowchart illustrating an example method 800, which may be performed by the e-commerce platform 100, for example using a user activity engine 600, for processing user activity data 663 from different users and determining a sub-user account ID 661a, 661b, 661c based on one or more user action data such as user biometric data 667.

At step 810, the user activity engine 600 receives user activity data 663 from a customer device 150 associated with a master user account 660. For example, user activity data 663 may include browsing history and purchasing history. Browsing history may include a detailed log or record of websites that a user has visited in the past, including information such as a name of each website, a visit timestamp of each website, a visit duration of each website, a web link of each website, download history, search history, and/or cookies. User activity data 663 may be further associated with a sub-user account 665a, 665b, 665c within the master user account 660, if and when a sub-user account 665a, 665b, 665c is identified for the user activity data 663a, 663b, 663c.

At step 820, the user activity engine 600 can receive or retrieve user biometric data 667 associated with the master user account 600. User biometric data 667 may include one or more types of biometric data, such as keystroke dynamic data, mouse dynamic data, or touchscreen data as discussed above. The user biometric data 667 may be captured at the customer device 150 used to generate the user activity data 663; that is, a collection of user activity data 663 may correspond to a collection of user biometric data 667, as both data 663, 667 are received from the customer device 150 during the same time period. Therefore, a sub-user account ID determined based on the user biometric data 667 may be used to assign or store the corresponding user activity data 663 collected during the same period.

At step 830, the user activity engine 600 can generate one or more current action metrics based on the received user biometric data 667. The user activity engine 600 may convert each type of user biometric data 667 (e.g., keystroke dynamic data, mouse dynamic data, or touchscreen data) to a corresponding action metric. A current action metric may be computed based on combining all action metrics generated based on the user biometric data 667.

At step 840, the user activity engine 600 can compare the generated current action metric to one or more stored action metrics associated with the master user account 600 in order to find a match between the current action metric and a stored action metric. Specifically, the master user account 600 may have a plurality of sub-user accounts 665a, 665b, 665c, with each sub-user account 665a, 665b, 665c having a respective unique sub-user account ID 661a, 661b, 661c and a respective set of historical user activity data 663a, 663b, 663c. Each sub-user account ID 661a, 661b, 661c may be further linked to one or more stored action metrics 900a, 900b, 900c, and each of the stored action metrics 900a, 900b, 900c may include an action metric 910, 920, 930 for each type of user biometric data 667. Further, each of the stored action metrics 900a. 900b, 900c as well as an average action metric 950 calculated based on the stored action metrics 910, 920, 930 for each type of user biometric data 667.

In some embodiments, a feature vector can be generated by an action metric module 620 of the user activity engine 600 based on the current action metric. For example, the feature vector may include a sequence of values [A, B, C, D, E, F, G], corresponding to one or more action metrics, e.g., [vertical mouse target offset, horizontal mouse target offset, average time difference between “t” and “h”, average time difference between “h” and “e”, vertical touch target offset, horizontal touch target offset, average touch swiping pressure, average touch swiping speed].

A sub-user account module 630 in the user activity engine 600 can generate one comparator vector based on one or more stored action metrics for each sub-user account ID 661a, 661b, 661c. The sub-user account module 630 may compare the feature vector generated by the action metric module 620 to each comparator factor included in the comparator vector associated with a respective sub-user account ID 661a, 661b, 661c.

The comparison can be performed statistically, for example, a statistical probability can be calculated based on an array of differences between the feature vector and a corresponding comparator vector. If any element in the feature vector or the comparator vector is null, then the respective difference can be set to null. For instance, for a feature vector [null, 5, 0.5, 0.3, 4, 7, 9, 5] and a corresponding comparator vector [−4, 5, 0.35, 0.3, 5, 7, 8.5, 5], the resulting array of differences between the two vectors is [null, 0, 0.15, 0, −1, 0, 0.5, 0].

An overall statistical probability can be calculated based on a predefined maximum difference threshold for each element in the array of differences, which represents a likelihood that the feature vector matches with a particular comparator vector.

A probability distribution curve P for a feature vector of a particular type of user biometric data (e.g. keystroke dynamic data) for a sub-user account may define a probability of a variable X, which can be a numeric value for a particular action metric data (e.g. latency between ‘h’ and ‘a’) appearing in the feature vector. In some example embodiments, given a feature vector V1 and a comparator vector V2, a probability distribution curve based on the comparator vector V2 can be used to determine a probability p(x) of a value x (e.g. latency of 4 ms between ‘a’ and ‘b’) appearing in the feature vector V1, assuming V1 and V2 belong to the same sub-user account. Then, for example, if V1 does not include 4 ms (or a value sufficiently close to 4 ms, such as 3.9 ms) for a latency value between ‘a’ and ‘b’ when the probability p(4 ms) is over a minimum threshold (e.g., 90%), the sub-user account module 630 may determine that V1 does not match V2, i.e., the feature vector V1 does not belong to the sub-user account associated with the comparator vector V2.

In some embodiments, multiple probabilities, each computed for a distinct action metric data value based on the probability distribution curve P, may be assessed prior to determining if and when a feature vector V1 matches a comparator vector V2. For example, a probability value p may be computed for each action metric data in V2, and for each probability value p higher than 95%, a corresponding action metric data value (or a value sufficiently close to it) must appear in the feature vector V1 before the sub-user account module 630 can determine that V1 and V2 belong to the same sub-user account.

The probability distribution curve P for a particular action metric data for a sub-user account may be a normal curve, or a curve represented by a probability density function determined in experiments based on prior feature vector data for the sub-user account.

In some embodiments, instead of using the probability of a specific action data metric value, probabilities across multiple action metric data values in a given feature vector may be averaged to obtain a single value representative of those probabilities for the entire feature vector. That single value may be used to match a feature vector based on a comparison to a predefined match threshold.

In some embodiments, the probability value p of at least one action metric data value appearing in a feature vector V1 based on a probability distribution curve P may be weighed more than that of some or all of the rest of the action metric data values when generating a representative value by averaging probabilities as discussed above (e.g., using a weighted average) This may be true when the at least one action metric data value has a type of action metric data that is associated with the lowest standard deviation (i.e., very consistent action metrics), or when the action metric data type of this particular sub-user account is rather far from a population average, i.e., the user associated with the sub-user account tends to perform the underlying action in an unique way compared to the global population.

In another example, using the feature vector and the comparator vector examples above, the array of differences is [null, 0, 0.15, 0, −1, 0, 0.5, 0]. Each element in the array corresponds to a type of action metric and can be associated with a redefined maximum difference threshold. For example, the value 0.15 mm, which is the third element in the array, represents a difference between the feature vector and the comparator vector for the action metric “horizontal mouse target offset”, which may have a predefined maximum threshold of 0.2 mm. As 0.15 mm is less than 0.2 mm, this particular element for “horizontal mouse target offset” in the feature vector is considered to be matched to its corresponding element in the comparator vector. The same analysis may be performed for each non-null element in the array of differences for the feature vector and the comparator vector, and a statistical probability may be generated based on the number of matched elements (e.g., based on a number of matched elements as a fraction of the total number of elements) and/or which of the elements are matched (e.g., where the various elements are associated with features having different degrees of predictiveness as regards an overall match).

A minimum threshold (e.g. 70%) may be pre-defined for determining when a match occurs, such that if the statistical probability (the likelihood) is above the minimum threshold, the feature vector is determined to be associated with the sub-user account ID 661a, 661b, 661c of the particular comparator vector. In some embodiments, in addition to the statistical probability, there may be, in order to determine that the feature vector is determined to be associated with the sub-user account of the comparator vector, an additional requirement of having some value calculated based on differences between the feature vector and the comparator vector (e.g., on an element-by-element basis) being less than a threshold/thresholds.

In some cases, multiple comparator vectors associated with multiple sub-user account IDs 661a, 661b, 661c may appear to be a match for a feature vector, and the sub-user account module 630 can select the comparator vector that has the highest likelihood (e.g. the least standard deviation) of matching the feature vector. In other embodiments, for a given period ending at t₁, the sub-user account module 630 can simply choose the sub-user account ID 661a, 661b, 661c that has been matched to an immediately preceding feature vector generated during the same browsing session based on user biometric data received at an earlier time t₀, if the time period between t₀ and t₁ is less than or equal to a certain threshold (e.g. 5 seconds).

At step 850, when a match is found between the current action metric(s) and a stored action metric, a sub-user account ID 661a, 661b, 661c associated with the stored action metric is retrieved and used as a current sub-user account ID, which may also be referred to as a matching sub-user account ID. In addition, the sub-user account module 630 may update the stored action metric 910, 920, 930, 950 for the particular sub-user account ID 661a, 661b, 661c based on the current action metric in order to further refine the stored action metric for the sub-user account ID 661a, 661b, 661c. For example, one or more action metrics used to generate the current action metric may be stored as an additional action metric and may be used in updating an average action metric 950 for the sub-user account ID 661a, 661b, 661c.

In some embodiments, the user activity engine 600 may use a browsing history such as a shopping history of each sub-account user within the same master user account 660 to create a shopping social graph, where each edges of the social graph represents an action taken on a product (viewed, added to cart, purchased, etc.), and each node represents a product and a merchant, and leverage the clustering of strong interconnections to determine a shopping pattern for each sub-account user. For example, most users may be inclined to browse or purchase a second product (e.g. patio umbrella) after browsing or purchasing a first product (e.g. patio dining set). This social graph may be used to further help the user activity data differentiate different sub-users within the same master user account 660.

For example, when a match is found between a feature vector and a comparator vector, an additional step may be undertaken by the user activity engine 600 to examine a social graph generated based on the user activity data 663 and a social graph generated based on the historical activity data 663a, 663b, 663c associated with the comparator vector, in order to confirm that the match is accurate. In some embodiments, if the comparison of the social graphs indicates that the user activity data 663 may correspond to a different individual (user) from a user of the sub-user account ID associated with the comparator vector, the user activity engine 600 may be configured to determine/signal that no match is found.

For example, in some embodiments, the user activity engine 600 can first determine that a current action metric generated based on user biometric data of user C received during a browsing session is a match for a stored action metric associated with a sub-user account S, it then checks to see if a shopping social graph exists for the sub-user account S. If a social graph exists for the sub-user account S, the user activity engine 600 proceeds to review a set of current user activity data of user C based on the social graph of the sub-user account S. When the current user activity data of user C show different shopping behaviors from those suggested by one or more clusters on the social graph of the sub-user account S, the user activity engine 600 can determine that additional user biometric data and action metric may be required to further determine if user C should be the owner of the sub-user account S. In this case, the user activity engine 600 proceeds to analyze at least one more set of user biometric data of user C to generate a most recent current action metric in order to determine if user C should be matched to sub-user account S. If the corresponding current action metric of user C is matched to the sub-user account S again, then the user activity engine 600 can conclude that the match is correct, otherwise, the user activity engine 600 can conclude that no match is found.

At step 860, responsive to a match between the current action metric(s) and a stored action metric not being found, a new sub-user account may be created with a new sub-user account ID. The new sub-user account may be immediately usable as a matching sub-user account.

At step 870, the user activity engine 600 may store the received user activity data 663 in a matching sub-user account 665a, 665b, 665c based on a corresponding sub-user account ID, whether previously existing or newly created. The user activity engine may store the received user activity data 663 as an additional set of historical user activity data 663a, 663b, 663c in the matching sub-user account 665a, 665b, 665c.

In some embodiments, once a specific sub-user account 665a, 665b, 665c has been determined for user activity data 663 received during a browsing session, only the sub-user account setting may be modified based on the user activity data 663. For example, if the user activity data 663 indicates that the user has changed one or more user settings in the master user account 660 during the same browsing session, the user activity engine 600 may change a corresponding setting in the specific sub-user account 665a, 665b, 665c to reflect the user change, while ensuring that the rest of the sub-user accounts in the master user account 600 remain unaffected by the user changes. For instance, if this user has changed a default language setting from English to French, or changed a shipping address from New York to Montreal, the new settings may be considered to be applicable only to this particular user, and therefore only reflected in the specific sub-user account 665a, 665b, 665c identified earlier based on the user action data of the user. This way, another user accessing the same master user account 600 with the same set of user authentication information need not be surprised by a French website upon logging into the master user account 600.

The user activity engine 600 may have a setting allowing it to be selectively configured to delete the received user activity data 663 if a match is not found. At step 880, responsive to a match between the current action metric(s) and a stored action metric not being found, the user activity engine 600 may delete the user activity data 663 if that setting has been used to configure the user activity engine 600 to perform deletions responsive to a match not being found.

The user activity engine 600 may perform the steps 810 to 870 (or to 880) periodically. The period for executing each performance cycle of the method 800 may be pre-defined, such as, for example, a period of N seconds. For example, user activity engine 600 may be configured to examine the user biometric data 667 received every N seconds, and determine a sub-user account ID based on the received user biometric data 667 every N seconds.

After a specific sub-user account ID 661a, 661b, 661c is determined based on the user action data (e.g. based on user biometric data 667 or browsing history from historical activity data), the user activity engine 600 may first store the user activity data 663 in a sub-user account identified by the specific sub-user account ID 661a, 661b, 661c. The user activity engine 600 may, in some embodiments, send the user activity data 663 and the specific sub-user account ID 661a, 661b, 661c to another server for generating targeted advertisement offers, which can be crafted based on the user activity data 663. The specific sub-user account ID 661a, 661b, 661c may be used to display the targeted advertisement offers once someone has logged into the master user account 660 again and is determined to be the user associated with the specific sub-user account ID 661a, 661b, 661c.

In some embodiments, prior to determining a specific sub-user account ID 661a, 661b, 661c based on the user activity data 663, the user activity engine 600 may send the user activity data 663 without any user account ID to another server, where the user activity data 663 has a session ID or a timestamp. Responsive to a specific sub-user account ID 661a, 661b, 661c having been determined based on user action data in accordance with method 800 or a different method, the user activity engine 600 may attach the determined sub-user account ID 661a, 661b, 661c to the user activity data 663, and send the determined sub-user account ID 661a, 661b, 661c together with the session ID or the timestamp to the server. In this way, the server may identify the user activity data 663 as belonging to the determined sub-user account ID 661a, 661b, 661c.

In some embodiments, the stored user activity 663 can be tagged with the determined sub-user account ID 661a, 661b, 661c and sent asynchronously to another server for generating targeted advertisement offers or promotions.

In some embodiments, the user activity engine 600 may simply delete user activity data that does not matched any of the sub-user account IDs 661a, 661b, 661c (i.e., user activity data that fails matching) based on user action data.

In some embodiments, the user activity engine 600 may insert one or more tokens, cookies or fingerprints to a user's browsing session, in order to generate a segregated shopping/browsing proxy to detect the shopping/browsing history as associated with two or more sub-user accounts. In some embodiments, when the user activity engine 600 detects N sub-user accounts associated with a master user account on a device, N+1 cookies may be used to track the individual sessions, where a respective cookie is used to facilitate individual sessions associated with a respective sub-user account, and an additional cookie may be used to facilitate browsing sessions common to all users of the master user account.

For example, when a user accesses a web application hosted by the e-commerce platform 100 and logs into a master user account 600, two browsing sessions may be initiated by the user activity engine 600 using two respective cookie requests in quick succession. If a browser fingerprinting attempt by a web server is detected, then a virtual browser or a browser in incognito mode, may be generated to intercept the browser fingerprinting attempt.

The first cookie can be associated with the master user account 600, while the second cookie can be used to request all subsequent actions after a user has logged into the master user account 600.

User action data, including user biometric data 667 and user activity data 663 are received and stored in either a local or remote resource, together with the second cookie.

Once a sub-user account ID has been determined based on the user action data in accordance with the described process 800 above, the user activity engine 800 may use the first cookie associated with the user action data to continue monitor and store user activity data 663.

If the user is determined to be a new user—i.e., a new sub-user account is created, a third cookie may be requested for accessing the web resources.

Besides using the segregated user activity data to craft and send better targeted ads, other applications of the subject matter of the present application may include serving different web content based the sub-user profile/ID detected. For example, language setting and/or shipping addresses may be maintained on a sub-user basis. In another example, privacy for users of the same user account may be enhanced by hiding browsing activities done by a one user of the account from another user of the same user account.

Conveniently, instead of using a single set of login information or a single device as a proxy for an individual user, the described system leverages user action data to identify one or more individuals that may use the same login information or the same device to access an e-commerce system or website. Notably, this identification may need to be performed in real time (or near real time). For example, conveniently, by analyzing user action data from a user account in real time (or near real time) and comparing the user action data analytics to existing user action metrics of existing sub-user accounts, the system may readily identify a current user matching a sub-user account or if a match is not found, a new sub-user account may be created.

The system may then associate or map a sub-user account ID to some or all user activities that occurred during the same timeframe as the user action data, thereby segregating user activities of multiple users sharing the same master user account.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

All referenced documents are hereby incorporated by reference in their entireties.

1. A method of processing user activity data associated with a master user account, the method comprising:
receiving user activity data associated with a master user account, the user activity data collected at a user device over a time period;
receiving user biometric data associated with the master user account, the user biometric data generated based on physical interactions of a user with the user device over the time period;
identifying a matching sub-user account corresponding to the user within the master user account based on a comparison between the user biometric data and one or more stored action metrics associated with the master user account; and
storing the user activity data in association with the matching sub-user account within the master user account.

2. The method of claim 1, wherein the user activity data comprises activity data collected by a web browser executing at the user device and wherein the user biometric data comprises biometric data corresponding to input received by the web browser.

3. The method of claim 1, wherein the user activity data comprises browser history data.

4. The method of claim 1, wherein identifying the matching sub-user account comprises: generating a new sub-user account for the user responsive to the comparison between the user biometric data and the one or more stored action metrics associated with the master user account not identifying a match; and storing the user activity data in association with the new sub-user account.

5. The method of claim 1, wherein the user biometric data comprises at least one of: keystroke dynamic data, mouse dynamic data, and touchscreen data.

6. The method of claim 1, wherein identifying a matching sub-user account corresponding to the user within the master user account based on a comparison between comparing the user biometric data and the one or more stored action metrics associated with the master user account comprises:
determining a current action metric based on the user biometric data;
comparing the current action metric to the one or more stored action metrics associated with the master user account; and
determining the matching sub-user account based on the comparison between the current action metric and the one or more stored action metrics.

7. The method of claim 6, wherein the one or more stored action metrics comprises a plurality of stored action metrics and wherein each of the plurality of stored action metrics corresponds to a respective sub-user account associated with the master user account.

8. The method of claim 7, wherein when the current action metric is equal to or within a defined threshold of an action metric of the plurality of stored action metrics, the matching sub-user account is determined to be a sub-user account corresponding to that action metric.

9. The method of claim 1, further comprising:
sending the user activity data and the sub-user account ID to a server for use in generating targeted advertisement offers.

10. The method of claim 1, further comprising:
prior to attaching the sub-user account ID of the matching sub-user account to the user activity data, sending the user activity data without any user ID to a server for use in generating targeted advertisement offers, wherein the user activity data includes one of a session ID and a timestamp; and
after attaching the sub-user account ID of the matching sub-user account to the user activity data, sending the sub-user account ID together with the one of the session ID and the timestamp to the server.

11. The method of claim 1, further comprising:
receiving new user activity data and new user biometric data associated with the master user account; and
deleting the new activity data responsive to determining that the new user biometric data does not match an action metric stored in association with the master user account.

12. A system for processing user activity data associated with a master user account, the system comprising:
a processing device in communication with a memory storage, the processing device configured to execute instructions stored in the memory storage to cause the system to:
receive user activity data associated with a master user account, the user activity data collected at a user device over a time period;
receive user biometric data associated with the master user account, the user biometric data generated based on physical interactions of a user with the user device over the time period;
identify a matching sub-user account corresponding to the user within the master user account based on a comparison between the user biometric data and one or more stored action metrics associated with the master user account; and
store the user activity data in association with the matching sub-user account within the master user account.

13. The system of claim 12, wherein the processing device is configured to execute instructions stored in the memory storage to cause the system to:
generate a new sub-user account for the user responsive to the comparison between the user biometric data and the one or more stored action metrics associated with the master user account not identifying a match; and
store the user activity data in association with the new sub-user account.

14. The system of claim 12, wherein the processing device is configured to execute instructions stored in the memory storage to cause the system to:
determine a current action metric based on the user biometric data;
compare the current action metric to the one or more stored action metrics associated with the master user account; and
determine the matching sub-user account based on the comparison between the current action metric and the one or more stored action metrics.

15. The system of claim 14, wherein the one or more stored action metrics comprises a plurality of stored action metrics and each of the plurality of stored action metrics corresponds to a respective sub-user account associated with the master user account.

16. The system of claim 15, wherein when the current action metric is equal to or within a defined threshold of an action metric of the plurality of stored action metrics, the matching sub-user account is determined to be a sub-user account corresponding to that action metric.

17. The system of claim 12, wherein the processing device is configured to execute instructions stored in the memory storage to cause the system to:
send the user activity data and the sub-user account ID to a server for use in generating targeted advertisement offers.

18. The system of claim 12, wherein the processing device is configured to execute instructions stored in the memory storage to cause the system to:
prior to attaching the sub-user account ID of the matching sub-user account to the user activity data, send the user activity data without any user ID to a server for use in generating targeted advertisement offers, wherein the user activity data includes one of a session ID and a timestamp; and
after attaching the sub-user account ID of the matching sub-user account to the user activity data, send the sub-user account ID together with the one of the session ID and the timestamp to the server.

19. The system of claim 12, wherein the processing device is configured to execute instructions stored in the memory storage to cause the system to:
receive new user activity data and new user biometric data associated with the master user account; and
delete the new activity data responsive to determining that the new user biometric data does not match an action metric stored in association with the master user account.

20. A non-transitory computer readable medium having stored thereon instructions for processing user activity data associated with a master user account, the instructions including machine executable code which when executed by at least one processor, causes the at least one processor to:
receive user activity data associated with a master user account, the user activity data collected at a user device over a time period;
receive user biometric data associated with the master user account, the user biometric data generated based on physical interactions of a user with the user device over the time period;
identify a matching sub-user account corresponding to the user within the master user account based on a comparison between the user biometric data and one or more stored action metrics associated with the master user account; and
store the user activity data in association with the sub-user account within the master user account.
